(19) United States
(12) Patent Application Publication
(10) Pub. No.: US 2023/0153884 A1
(43) Pub. Date: May 18, 2023

(54) Cross-platform Facilitation of Application Installation for VR Systems

(71) Applicant: META PLATFORMS TECHNOLOGIES, LLC, Menlo Park, CA (US)

(72) Inventors: Vaishali Parekh, San Francisco, CA (US); Aaron Draczynski, Burlington, CT (US); Yang Zhou, Mercer Island, WA (US); Jiakang Lu, San Mateo, CA (US); Kairen Ye, Mountain View, CA (US); Kevin Hsu, Fremont, CA (US); Kenneth Andrew Sheedlo, Arvada, CO (US)

(21) Appl. No.: 17/529,052

(22) Filed: Nov. 17, 2021

(51) Int. Cl. G06Q 30/06; G06F 16/9536

(52) U.S. Cl. CPC G06Q 30/0631; G06F 16/9536; G06Q 30/0643

(57) ABSTRACT

In one embodiment, a method includes sending instructions for presenting a content recommendation associated with a virtual-reality (VR) application to a client system associated with a user, wherein the content recommendation comprises an interactable element for installing the VR application, receiving an indication of an activation of the interactable element for installing the VR application from the client system, and sending instructions for automatically downloading the VR application to the VR system to a VR system associated with the user responsive to the indication received from the client system, wherein the VR system is separate from the client system, the VR application being automatically installed on the VR system after downloading of the VR application to the VR system.

### TECHNICAL FIELD

This disclosure generally relates to databases and file management within network environments, and in particular relates to application management for virtual reality (VR) systems.

### BACKGROUND

Standard virtual reality systems use either virtual reality headsets or multi-projected environments to generate realistic images, sounds and other sensations that simulate a user's physical presence in a virtual environment. A person using virtual reality equipment is able to look around the artificial world, move around in it, and interact with virtual features or items. The effect is commonly created by VR headsets consisting of a head-mounted display with a small screen in front of the eyes but can also be created through specially designed rooms with multiple large screens. Virtual reality typically incorporates auditory and video feedback but may also allow other types of sensory and force feedback through haptic technology.

Virtual reality applications are applications that make use of virtual reality (VR), an immersive sensory experience that digitally simulates a virtual environment. Applications have been developed in a variety of domains, such as education, architectural and urban design, digital marketing and activism, engineering and robotics, entertainment, virtual communities, fine arts, healthcare and clinical therapies, heritage and archaeology, occupational safety, social science and psychology.

### SUMMARY OF PARTICULAR EMBODIMENTS

In particular embodiments, one or more computing systems (e.g., a social-networking system or a VR platform) may effectively deliver content recommendations of VR applications to users of VR devices who do not have these applications installed and enable the users to conveniently download and install them on their VR devices. On a VR device, developers of VR applications may not be able to run content recommendations effectively because it may be difficult for them to target users or calculate conversions, so they need to monetize by selling their applications. To do so, users may need to be routed to the application store to purchase the applications. The one or more computing systems may provide a solution as a content-recommendation feature specifically for these VR applications. It may allow developers to create content recommendations that target known users of VR devices who do not have their specific VR applications installed. The content recommendations may only be shown to users who have VR devices (e.g., such information may be known because they have created an account associated with the social-networking system). When the users are using an application associated with the social-networking system, customized content recommendations for VR applications may be shown to the users. The content-recommendation feature may be available on any suitable client system (e.g., a smart phone, a tablet, etc.) where the user is using a social-networking application associated with the social-networking system. If the user clicks on a content recommendation, they may be directed to a user interface for purchasing a corresponding VR application. Different from how existing application installation works, the content-recommendation feature may enable a VR application to be installed from a first-party application store via a content recommendation on a first-party application (e.g., a recommendation for a VR application on a photo-sharing application to install that VR application from a VR application store). Furthermore, the content-recommendation feature may bypass the application store and install an application directly on a target VR device, which may be also different from current application installation procedures, where an application store makes a user download the application to the specific device being used to access the application store. After the user purchases the VR application, it may be automatically downloaded to and installed on the VR device. Although this disclosure describes facilitating installation of particular applications by particular systems in a particular manner, this disclosure contemplates facilitating installation of any suitable application by any suitable system in any suitable manner.

In particular embodiments, the one or more computing systems may send, to a client system associated with a user, instructions for presenting a content recommendation associated with a virtual-reality (VR) application. The content recommendation may comprise an interactable element for installing the VR application. The one or more computing systems may then receive, from the client system, an indication of an activation of the interactable element for installing the VR application. The one or more computing systems may further send, to a VR system associated with the user responsive to the indication received from the client system, instructions for automatically downloading the VR application to the VR system. In particular embodiments, the VR system may be separate from the client system. The VR application may be automatically installed on the VR system after downloading of the VR application to the VR system.

Certain technical challenges exist for enabling installation of a VR application. One technical challenge may include seamlessly navigating a user to details of a VR application within a non-VR platform. The solution presented by the embodiments disclosed herein to address this challenge may be presenting a product detail page (PDP) of the VR application within a companion application after user clicks a deep link of the PDP which is associated with a user interface (UI) within the companion application, as the companion application is installed at the non-VR platform and the PDP may be easily accessed via the deep link within the companion application. Another technical challenge may include enabling a user to quickly purchase a VR application. The solution presented by the embodiments disclosed herein to address this challenge may be a convenient checkout feature which enables the user to stay in the non-VR application and finish purchasing the VR application, as the user may open either an in-app screen to finish the purchase or be directed to an in-app web browser to finish the purchase.

Certain embodiments disclosed herein may provide one or more technical advantages. A technical advantage of the embodiments may include enabling developers to promote their applications and expedite monetization for more high-quality applications to attract more users on the VR platform and enabling users to discover applications that may improve their experiences with the VR platform as the social-networking system may effectively target users by surfacing content recommendations of VR applications in a family of applications associated with the social-networking system. Another technical advantage of the embodiments may include enabling a user to easily install a VR application without switching platforms, as the VR application may be automatically downloaded to and installed on the user's VR device after the user purchases it from a non-VR platform. Certain embodiments disclosed herein may provide none, some, or all of the above technical advantages. One or more other technical advantages may be readily apparent to one skilled in the art in view of the figures, descriptions, and claims of the present disclosure.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example network environment associated with a mixed-reality (MR) system.

FIG. 2 illustrates an example virtual reality (VR) system worn by a user.

FIG. 3A illustrates an example user interface of VR content recommendation on a smart phone.

FIG. 3B illustrates another example user interface of VR content recommendation on the smart phone.

FIG. 4 illustrates an example product detail page.

FIG. 5 illustrates an example user interface for purchase confirmation.

FIG. 6A illustrates an example recommendation of a VR application/game in a non-VR application.

FIG. 6B illustrates an example product detail page within the non-VR application.

FIG. 6C illustrates an example user interface for purchase confirmation.

FIG. 7 illustrates an example interaction flow between a social-networking system, a client system, a VR display device, and a VR platform.

FIG. 8 illustrates an example method for enabling installation of a VR application.

FIG. 9 illustrates an example social graph.

FIG. 10 illustrates an example computer system.

### DESCRIPTION OF EXAMPLE EMBODIMENTS

### System Overview

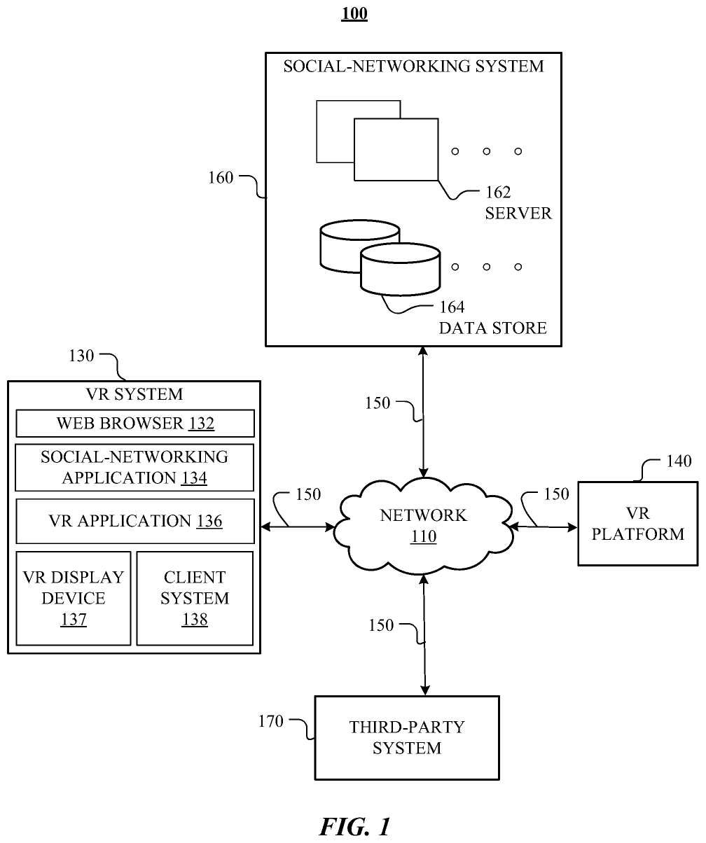

FIG. 1 illustrates an example network environment 100 associated with a virtual-reality (VR) system 130. Network environment 100 includes the VR system 130, a virtual-reality (VR) platform 140, a social-networking system 160, and a third-party system 170 connected to each other by a network 110. Although FIG. 1 illustrates a particular arrangement of a VR system 130, a VR platform 140, a social-networking system 160, a third-party system 170, and a network 110, this disclosure contemplates any suitable arrangement of a VR system 130, a VR platform 140, a social-networking system 160, a third-party system 170, and a network 110. As an example and not by way of limitation, two or more of a VR system 130, a social-networking system 160, a VR platform 140, and a third-party system 170 may be connected to each other directly, bypassing a network 110. As another example, two or more of a VR system 130, a VR platform 140, a social-networking system 160, and a third-party system 170 may be physically or logically co-located with each other in whole or in part. Moreover, although FIG. 1 illustrates a particular number of VR systems 130, VR platforms 140, social-networking systems 160, third-party systems 170, and networks 110, this disclosure contemplates any suitable number of VR systems 130, VR platforms 140, social-networking systems 160, third-party systems 170, and networks 110. As an example and not by way of limitation, network environment 100 may include multiple VR systems 130, VR platforms 140, social-networking systems 160, third-party systems 170, and networks 110.

This disclosure contemplates any suitable network 110. As an example and not by way of limitation, one or more portions of a network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular technology-based network, a satellite communications technology-based network, another network 110, or a combination of two or more such networks 110.

Links 150 may connect a VR system 130, a VR platform 140, a social-networking system 160, and a third-party system 170 to a communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout a network environment 100. One or more first links 150 may differ in one or more respects from one or more second links 150.

In particular embodiments, a VR system 130 may be any suitable electronic device including hardware, software, or embedded logic components, or a combination of two or more such components, and may be capable of carrying out the functionalities implemented or supported by a VR system 130. As an example and not by way of limitation, the VR system 130 may include a computer system such as a desktop computer, notebook or laptop computer, netbook, a tablet computer, e-book reader, GPS device, camera, personal digital assistant (PDA), handheld electronic device, cellular telephone, smartphone, smart speaker, smart watch, smart glasses, augmented-reality (AR) smart glasses, virtual reality (VR) headset, other suitable electronic device, or any suitable combination thereof. This disclosure contemplates any suitable VR systems 130. In particular embodiments, a VR system 130 may enable a network user at a VR system 130 to access a network 110. The VR system 130 may also enable the user to communicate with other users at other VR systems 130.

In particular embodiments, a VR system 130 may include a web browser 132, and may have one or more add-ons, plug-ins, or other extensions. A user at a VR system 130 may enter a Uniform Resource Locator (URL) or other address directing a web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to a VR system 130 one or more Hyper Text Markup Language (HTML) files responsive to the HTTP request. The VR system 130 may render a web interface (e.g. a webpage) based on the HTML files from the server for presentation to the user. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts, combinations of markup language and scripts, and the like. Herein, reference to a web interface encompasses one or more corresponding source files (which a browser may use to render the web interface) and vice versa, where appropriate.

In particular embodiments, a VR system 130 may include a social-networking application 134 installed on the VR system 130. A user at a VR system 130 may use the social-networking application 134 to access on online social network. The user at the VR system 130 may use the social-networking application 134 to communicate with the user's social connections (e.g., friends, followers, followed accounts, contacts, etc.). The user at the VR system 130 may also use the social-networking application 134 to interact with a plurality of content objects (e.g., posts, news articles, ephemeral content, etc.) on the online social network. As an example and not by way of limitation, the user may browse trending topics and breaking news using the social-networking application 134.

In particular embodiments, a VR system 130 may include a VR application 136. As an example and not by way of limitation, a virtual reality (VR) application 136 may be able to incorporate VR renderings of real-world objects from the real-world environment into a VR environment. A user at a VR system 130 may use the VR applications 136 to interact with the VR platform 140. In particular embodiments, the VR application 136 may comprise a stand-alone application. In particular embodiments, the VR application 136 may be integrated into the social-networking application 134 or another suitable application (e.g., a messaging application). In particular embodiments, the VR application 136 may be also integrated into the VR system 130, a VR hardware device, or any other suitable hardware devices. In particular embodiments, the VR application 136 may be also part of the VR platform 140. In particular embodiments, the VR application 136 may be accessed via the web browser 132. In particular embodiments, the user may interact with the VR platform 140 by providing user input to the VR application 136 via various modalities (e.g., audio, voice, text, vision, image, video, gesture, motion, activity, location, orientation). The VR application 136 may communicate the user input to the VR platform 140. Based on the user input, the VR platform 140 may generate responses. The VR platform 140 may send the generated responses to the VR application 136. The VR application 136 may then present the responses to the user at the VR system 130 via various modalities (e.g., audio, text, image, video, and VR/AR rendering). As an example and not by way of limitation, the user may interact with the VR platform 140 by providing a user input (e.g., a verbal request for information of an object in the VR environment) via a microphone of the VR system 130. The VR application 136 may then communicate the user input to the VR platform 140 over network 110. The VR platform 140 may accordingly analyze the user input, generate a response based on the analysis of the user input, and communicate the generated response back to the VR application 136. The VR application 136 may then present the generated response to the user in any suitable manner (e.g., displaying a text-based push notification and/or VR rendering(s) illustrating the information of the object on a display of the VR system 130).

In particular embodiments, a VR system 130 may include a VR display device 137 and, optionally, a client system 138. The VR display device 137 may be configured to render outputs generated by the VR platform 140 to the user. The client system 138 may comprise a companion device. The client system 138 may be configured to perform computations associated with particular tasks (e.g., communications with the VR platform 140) locally (i.e., on-device) on the client system 138 in particular circumstances (e.g., when the VR display device 137 is unable to perform said computations). In particular embodiments, the VR system 130, the VR display device 137, and/or the client system 138 may each be a suitable electronic device including hardware, software, or embedded logic components, or a combination of two or more such components, and may be capable of carrying out, individually or cooperatively, the functionalities implemented or supported by the VR system 130 described herein. As an example and not by way of limitation, the VR system 130, the VR display device 137, and/or the client system 138 may each include a computer system such as a desktop computer, notebook or laptop computer, netbook, a tablet computer, e-book reader, GPS device, camera, personal digital assistant (PDA), handheld electronic device, cellular telephone, smartphone, smart speaker, virtual reality (VR) headset, augmented-reality (AR) smart glasses, other suitable electronic device, or any suitable combination thereof. In particular embodiments, the VR display device 137 may comprise a VR headset and the client system 138 may comprise a smart phone.

In particular embodiments, a user may interact with the VR platform 140 using the VR display device 137 or the client system 138, individually or in combination. In particular embodiments, an application on the VR display device 137 may be configured to receive user input from the user, and a companion application on the client system 138 may be configured to handle user inputs (e.g., user requests) received by the application on the VR display device 137. In particular embodiments, the VR display device 137 and the client system 138 may be associated with each other (i.e., paired) via one or more wireless communication protocols (e.g., Bluetooth).

The following example workflow illustrates how a VR display device 137 and a client system 138 may handle a user input provided by a user. In this example, an application on the VR display device 137 may receive a user input comprising a user request directed to the VR display device 137. The application on the VR display device 137 may then determine a status of a wireless connection (i.e., tethering status) between the VR display device 137 and the client system 138. If a wireless connection between the VR display device 137 and the client system 138 is not available, the application on the VR display device 137 may communicate the user request (optionally including additional data and/or contextual information available to the VR display device 137) to the VR platform 140 via the network 110. The VR platform 140 may then generate a response to the user request and communicate the generated response back to the VR display device 137. The VR display device 137 may then present the response to the user in any suitable manner. Alternatively, if a wireless connection between the VR display device 137 and the client system 138 is available, the application on the VR display device 137 may communicate the user request (optionally including additional data and/or contextual information available to the VR display device 137) to the companion application on the client system 138 via the wireless connection. The companion application on the client system 138 may then communicate the user request (optionally including additional data and/or contextual information available to the client system 138) to the VR platform 140 via the network 110. The VR platform 140 may then generate a response to the user request and communicate the generated response back to the client system 138. The companion application on the client system 138 may then communicate the generated response to the application on the VR display device 137. The VR display device 137 may then present the response to the user in any suitable manner. In the preceding example workflow, the VR display device 137 and the client system 138 may each perform one or more computations and/or processes at each respective step of the workflow. In particular embodiments, performance of the computations and/or processes disclosed herein may be adaptively switched between the VR display device 137 and the client system 138 based at least in part on a device state of the VR display device 137 and/or the client system 138, a task associated with the user input, and/or one or more additional factors. As an example and not by way of limitation, one factor may be signal strength of the wireless connection between the VR display device 137 and the client system 138. For example, if the signal strength of the wireless connection between the VR display device 137 and the client system 138 is strong, the computations and processes may be adaptively switched to be substantially performed by the client system 138 in order to, for example, benefit from the greater processing power of the CPU of the client system 138. Alternatively, if the signal strength of the wireless connection between the VR display device 137 and the client system 138 is weak, the computations and processes may be adaptively switched to be substantially performed by the VR display device 137 in a standalone manner. In particular embodiments, if the VR system 130 does not comprise a client system 138, the aforementioned computations and processes may be performed solely by the VR display device 137 in a standalone manner.

In particular embodiments, the VR platform 140 may comprise a backend platform or server for the VR system 130. The VR platform 140 may interact with the VR system 130, and/or the social-networking system 160, and/or the third-party system 170 when executing tasks.

In particular embodiments, the social-networking system 160 may be a network-addressable computing system that can host an online social network. The social-networking system 160 may generate, store, receive, and send social-networking data, such as, for example, user profile data, concept-profile data, social-graph information, or other suitable data related to the online social network. The social-networking system 160 may be accessed by the other components of network environment 100 either directly or via a network 110. As an example and not by way of limitation, a VR system 130 may access the social-networking system 160 using a web browser 132 or a native application associated with the social-networking system 160 (e.g., a mobile social-networking application, a messaging application, another suitable application, or any combination thereof) either directly or via a network 110. In particular embodiments, the social-networking system 160 may include one or more servers 162. Each server 162 may be a unitary server or a distributed server spanning multiple computers or multiple datacenters. As an example and not by way of limitation, each server 162 may be a web server, a news server, a mail server, a message server, an advertising server, a file server, an application server, an exchange server, a database server, a proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, the social-networking system 160 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a VR system 130, a social-networking system 160, a VR platform 140, or a third-party system 170 to manage, retrieve, modify, add, or delete, the information stored in data store 164.

In particular embodiments, the social-networking system 160 may store one or more social graphs in one or more data stores 164. In particular embodiments, a social graph may include multiple nodes—which may include multiple user nodes (each corresponding to a particular user) or multiple concept nodes (each corresponding to a particular concept)—and multiple edges connecting the nodes. The social-networking system 160 may provide users of the online social network the ability to communicate and interact with other users. In particular embodiments, users may join the online social network via the social-networking system 160 and then add connections (e.g., relationships) to a number of other users of the social-networking system 160 whom they want to be connected to. Herein, the term “friend” may refer to any other user of the social-networking system 160 with whom a user has formed a connection, association, or relationship via the social-networking system 160.

In particular embodiments, the social-networking system 160 may provide users with the ability to take actions on various types of items or objects, supported by the social-networking system 160. As an example and not by way of limitation, the items and objects may include groups or social networks to which users of the social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 160 or by an external system of a third-party system 170, which is separate from the social-networking system 160 and coupled to the social-networking system 160 via a network 110.

In particular embodiments, the social-networking system 160 may be capable of linking a variety of entities. As an example and not by way of limitation, the social-networking system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating the social-networking system 160. As an example and not by way of limitation, the entity operating the third-party system 170 may be a developer for one or more VR applications 136. In particular embodiments, however, the social-networking system 160 and third-party systems 170 may operate in conjunction with each other to provide social-networking services to users of the social-networking system 160 or third-party systems 170. In this sense, the social-networking system 160 may provide a platform, or backbone, which other systems, such as third-party systems 170, may use to provide social-networking services and functionality to users across the Internet.

In particular embodiments, a third-party system 170 may include a third-party content object provider. As an example and not by way of limitation, the third-party content object provider may be a developer for one or more VR applications 136. A third-party content object provider may include one or more sources of content objects, which may be communicated to a VR system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects. As yet another example and not by way of limitation, content objects may include one or more VR applications 136. In particular embodiments, a third-party content provider may use one or more third-party agents to provide content objects and/or services. A third-party agent may be an implementation that is hosted and executing on the third-party system 170.

In particular embodiments, the social-networking system 160 also includes user-generated content objects, which may enhance a user's interactions with the social-networking system 160. User-generated content may include anything a user can add, upload, send, or “post” to the social-networking system 160. As an example and not by way of limitation, a user communicates posts to the social-networking system 160 from a VR system 130. Posts may include data such as status updates or other textual data, location information, photos, videos, links, music or other similar data or media. Content may also be added to the social-networking system 160 by a third-party through a “communication channel,” such as a newsfeed or stream.

In particular embodiments, the social-networking system 160 may include a variety of servers, sub-systems, programs, modules, logs, and data stores. In particular embodiments, the social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The social-networking system 160 may also include suitable components such as network interfaces, security mechanisms, load balancers, failover servers, management-and-network-operations consoles, other suitable components, or any suitable combination thereof. In particular embodiments, the social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking the social-networking system 160 to one or more VR systems 130 or one or more third-party systems 170 via a network 110. The web server may include a mail server or other messaging functionality for receiving and routing messages between the social-networking system 160 and one or more VR systems 130. An API-request server may allow, for example, a VR platform 140 or a third-party system 170 to access information from the social-networking system 160 by calling one or more APIs. An action logger may be used to receive communications from a web server about a user's actions on or off the social-networking system 160. In conjunction with the action log, a third-party-content-object log may be maintained of user exposures to third-party-content objects. A notification controller may provide information regarding content objects to a VR system 130. Information may be pushed to a VR system 130 as notifications, or information may be pulled from a VR system 130 responsive to a user input comprising a user request received from a VR system 130. Authorization servers may be used to enforce one or more privacy settings of the users of the social-networking system 160. A privacy setting of a user may determine how particular information associated with a user can be shared. The authorization server may allow users to opt in to or opt out of having their actions logged by the social-networking system 160 or shared with other systems (e.g., a third-party system 170), such as, for example, by setting appropriate privacy settings. Third-party-content-object stores may be used to store content objects received from third parties, such as a third-party system 170. Location stores may be used for storing location information received from VR systems 130 associated with users. Advertisement-pricing modules may combine social information, the current time, location information, or other suitable information to provide relevant advertisements, in the form of notifications, to a user.

### Virtual Reality Systems

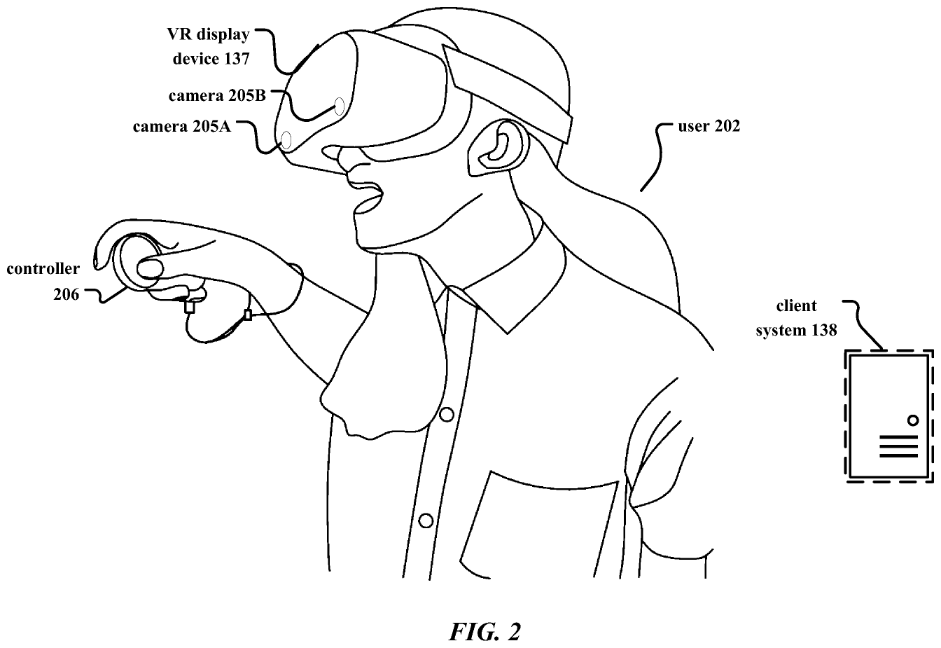

FIG. 2 illustrates an example of a virtual reality (VR) system 130 worn by a user 202. In particular embodiments, the VR system 130 may comprise a head-mounted VR display device 137, a controller 206, and one or more client systems 138. The VR display device 137 may be worn over the user's eyes and provide visual content to the user 202 through internal displays (not shown). The VR display device 137 may have two separate internal displays, one for each eye of the user 202 (single display devices are also possible). In particular embodiments, the VR display device 137 may comprise one or more external-facing cameras, such as the two forward-facing cameras 205A and 205B, which can capture images and videos of the real-world environment. The VR system 130 may further include one or more client systems 138. The one or more client systems 138 may be a stand-alone unit that is physically separate from the VR display device 137 or the client systems 138 may be integrated with the VR display device 137. In embodiments where the one or more client systems 138 are a separate unit, the one or more client systems 138 may be communicatively coupled to the VR display device 137 via a wireless or wired link. The one or more client systems 138 may be a high-performance device, such as a desktop or laptop, or a resource-limited device, such as a mobile phone. A high-performance device may have a dedicated GPU and a high-capacity or constant power source. A resource-limited device, on the other hand, may not have a GPU and may have limited battery capacity. As such, the algorithms that could be practically used by a VR system 130 depends on the capabilities of its one or more client systems 138.

### Cross-Platform Facilitation of Application Installation for VR Systems

In particular embodiments, one or more computing systems (e.g., a social-networking system 160 or a VR platform 140) may effectively deliver content recommendations of VR applications 136 to users of VR devices who do not have these applications installed and enable the users to conveniently download and install them on their VR devices. On a VR device, developers of VR applications 136 may not be able to run content recommendations effectively because it may be difficult for them to target users or calculate conversions, so they need to monetize by selling their applications. To do so, users may need to be routed to the application store to purchase the applications. The one or more computing systems may provide a solution as a content-recommendation feature specifically for these VR applications 136. It may allow developers to create content recommendations that target known users of VR devices who do not have their specific VR applications 136 installed. The content recommendations may only be shown to users who have VR devices (e.g., such information may be known because they have created an account associated with the social-networking system 160). When the users are using a social-networking application 134 associated with the social-networking system 160, customized content recommendations for VR applications 136 may be shown to the users. The content-recommendation feature may be available on any suitable client system 138 (e.g., a smart phone, a tablet, etc.) where the user is using a social-networking application 134 associated with the social-networking system 160. If the user clicks on a content recommendation, they may be directed to a user interface for purchasing a corresponding VR application 136. Different from how existing application installation works, the content-recommendation feature may enable a VR application 136 to be installed from a first-party application store via a content recommendation on a first-party application (e.g., a recommendation for a VR application 136 on a photo-sharing application to install that VR application 136 from a VR application store). Furthermore, the content-recommendation feature may bypass the application store and install an application directly on a target VR device, which may be also different from current application installation procedures, where an application store makes a user download the application to the specific device being used to access the application store. After the user purchases the VR application 136, it may be automatically downloaded to and installed on the VR device. Although this disclosure describes facilitating installation of particular applications by particular systems in a particular manner, this disclosure contemplates facilitating installation of any suitable application by any suitable system in any suitable manner.

In particular embodiments, the one or more computing systems may send, to a client system 138 associated with a user, instructions for presenting a content recommendation associated with a virtual-reality (VR) application 136. The content recommendation may comprise an interactable element for installing the VR application 136. The one or more computing systems may then receive, from the client system 138, an indication of an activation of the interactable element for installing the VR application 136. The one or more computing systems may further send, to a VR system 130 associated with the user responsive to the indication received from the client system 138, instructions for automatically downloading the VR application 136 to the VR system 130. In particular embodiments, the VR system 130 may be separate from the client system 138. The VR application 136 may be automatically installed on the VR system 130 after downloading of the VR application 136 to the VR system 130.

Content recommendations of VR applications 136 may help drive growth and create value. The value to users may include surfacing relevant VR applications 136 to them when they are in platforms that are different from a VR platform 130. The value to developers and creators may include providing VR developers and creators a way to drive acquisition and incremental revenue. The value to advertisers may include providing a new channel to reach people in immersive formats.

To help developers of VR applications 136 target users by promoting their applications and expedite monetization for more high-quality applications to attract more users on the VR platform 140, the social-networking system 160 or VR platform 140 may effectively deliver content recommendations (e.g., advertisements) of these applications to users who are on another platform. In particular embodiments, the social-networking system 160 or VR platform 140 may determine, based on user profile data associated with the user, that the VR application 136 is not installed on the VR system 130 associated with the user. Accordingly, sending instructions for presenting the content recommendation associated with the VR application 136 may be responsive to the determination.

Most developers may monetize by selling their VR applications 136. However, running content recommendations may be not a viable user acquisition strategy as developers may not meaningfully target VR users, calculate conversions, and optimize conversions. Research shows that finding relevant content (e.g., VR applications 136) may be also a problem for owners of VR devices. To solve for discovery, the social-networking system 160 may deliver application recommendations on a family of applications (FoA) associated with the social-networking system 160. To provide developers with new revenue streams and to increase the reach of FoA advertisers, the social-networking system 160 may surface advertisements in first-party and third-party applications. The content-recommendation feature of the social-networking system 160 may solve for both developer and people needs. Such functionality may allow developers to create content recommendations of VR applications 136 that target users of VR devices who do not have their specific applications installed. As a result, the embodiments disclosed herein may have a technical advantage of enabling developers to promote their applications and expedite monetization for more high-quality applications to attract more users on the VR platform 140 and enabling users to discover applications that may improve their experiences with the VR platform 140 as the social-networking system 160 may effectively target users by surfacing content recommendations of VR applications 136 in the family of applications associated with the social-networking system 160.

In particular embodiments, VR content recommendations may comprise a set of recommended products that support VR systems 130. As an example and not by way of limitation, the VR system 130 may comprise a VR headset and a companion application installed on the client system 138. The client system 138 may comprises one or more of a smart phone, an electronic tablet, or a personal computer. In particular embodiments, the example recommended products may include 2D/3D VR application 136 advertisements on the family of applications (FoA) to drive installations of applications. The 2D VR application 136 indicates the VR application 136 may be rendered as a two-dimensional (2D) user interface whereas the 3D VR application 136 indicates the VR application 136 may be rendered as a three-dimensional (3D) user interface.

In particular embodiments, content recommendations within FoA applications may comprise content recommendations of VR applications 136 for driving installations of these applications. In other words, the content recommendation associated with the VR application 136 may be presented via a first application installed on the client system 138. In particular embodiments, the first application may be rendered as a two-dimensional (2D) user interface. The first application may be a social-networking application 134. In particular embodiments, the social-networking system 160 may detect, at the client system 138, a user activity within the first application installed on the client system 138. Accordingly, sending instructions for presenting the content recommendation associated with the VR application 136 may be responsive to the detected user activity at the first application. As an example and not by way of limitation, the content recommendation may be built as an application-installation objective within an advertisement manager, with the VR application store integrated as a platform to drive installations. Developers may be able to use this objective to target owners of VR devices to drive installations of their applications and have access to different advertisement formats. When users see the advertisements, they may be able to click-through and land on the VR application store on a companion application installed on the client system 138 or on the web. These advertisements may be shown across the family of applications and ranked accordingly via the advertisements and business platform.

In particular embodiments, the social-networking system 160 or VR platform 140 may optimize the delivery of the content recommendations of VR applications 136 based on different weights in the recommendation models for users. Over time, the social-networking system 160 or VR platform 140 may add incremental signals from VR devices to the recommendation models for application-install recommendations. These signals may help content recommendations with delivery and ranking. To reduce purchase friction, the social-networking system 160 or VR platform 140 may improve conversion. To improve product flow conversion, the social-networking system 160 or VR platform 140 may enable one-click checkouts for users to purchase the VR applications 136.

In particular embodiments, when users see a content recommendation of a VR application 136 on a non-VR application using their non-VR client systems 138, they may click an installation option. After the user clicks on the installation option, the social-networking system 160 or VR platform 140 may enable the user to install the application as follows. In particular embodiments, the social-networking system 160 or VR platform 140 may detect a companion application associated with the VR system 130 installed on the client system 138. The social-networking system 160 or VR platform 140 may then embed a deep link to a product detail page (PDP) associated with the VR application 136 within the content recommendation. In particular embodiments, the deep link may be associated with a particular user interface (UI) within the companion application. By clicking on the deep link, the user may be directed to this UI, which may display the product detail page. The product detail page may comprise the interactable element (e.g., installation option). In particular embodiments, the social-networking system 160 or VR platform 140 may receive, from the client system 138, an indication of a user interaction with the deep link embedded within the content recommendation. The social-networking system 160 or VR platform 140 may further send, to the client system 138, instructions for presenting the product detail page within the companion application. Presenting a product detail page (PDP) of the VR application 136 within a companion application after user clicks a deep link of the PDP which is associated with a UI within the companion application may be an effective solution for addressing the technical challenge of seamlessly navigating a user to details of a VR application 136 within a non-VR platform, as the companion application is installed at the non-VR platform and the PDP may be easily accessed via the deep link within the companion application.

In particular embodiments, the social-networking system 160 or VR platform 140 may determine a companion application associated with the VR system 130 not installed on the client system 138. The social-networking system 160 or VR platform 140 may embed a URL link to a product detail page associated with the VR application 136 within the content recommendation. In particular embodiments, the URL link may be equivalent to a web link (e.g., https:// . . . ) associated with a particular webpage on the Internet. By clicking on the URL link, the user may be directed to this webpage, which may display the product detail page. The product detail page may comprise the interactable element. In particular embodiments, the social-networking system 160 or VR platform 140 may receive, from the client system 138, an indication of a user interaction with the URL link embedded within the content recommendation. The social-networking system 160 or VR platform 140 may further send, to the client system 138, instructions for directing the user to the product detail page via a web browser. If the companion application is not installed on the client system 138, the content recommendation may alternatively provide a deep link to the PDP within the same application the user is using, which may be opened either on an in-app browser or a standalone web browser.

After the product detail page is presented to the user, the user may purchase the VR application 136 from the product detail page. Once purchased, the VR application 136 may be automatically downloaded to and installed on the user's VR device. As a result, the embodiments disclosed herein may have technical advantage of enabling a user to easily install a VR application 136 without switching platforms, as the VR application 136 may be automatically downloaded to and installed on the user's VR device after the user purchases it from a non-VR platform. Alternatively, the content-recommendation feature may just unlock the VR application 136, allowing the user to download and install the application from the application store on the VR device the next time they use their VR devices.

In alternative embodiments, users may also be able to stay in the non-VR application and finish purchasing the VR application 136 with a convenient checkout feature provided by the social-networking system 160 or VR platform 140. As an example and not by way of limitation, users may open an in-app screen to finish the purchase or be redirected to an in-app web browser to finish the purchase. The convenient checkout feature which enables a user to stay in the non-VR application and finish purchasing the VR application 136 may be an effective solution for addressing the technical challenge of enabling a user to quickly purchase a VR application 136, as the user may open either an in-app screen to finish the purchase or be directed to an in-app web browser to finish the purchase.

In particular embodiments, when being redirected to an in-app web browser, the application PDP may be shown to the user before making the purchase. As another example and not by way of limitation, users may be redirected to an in-app “confirm purchase” screen. The user may then login and finish the purchase with the website. If entering the wrong password for their VR accounts, users may be shown an error notice. If entering the correct password for their VR accounts, users may be redirect to a “Thank you for your order” interface.

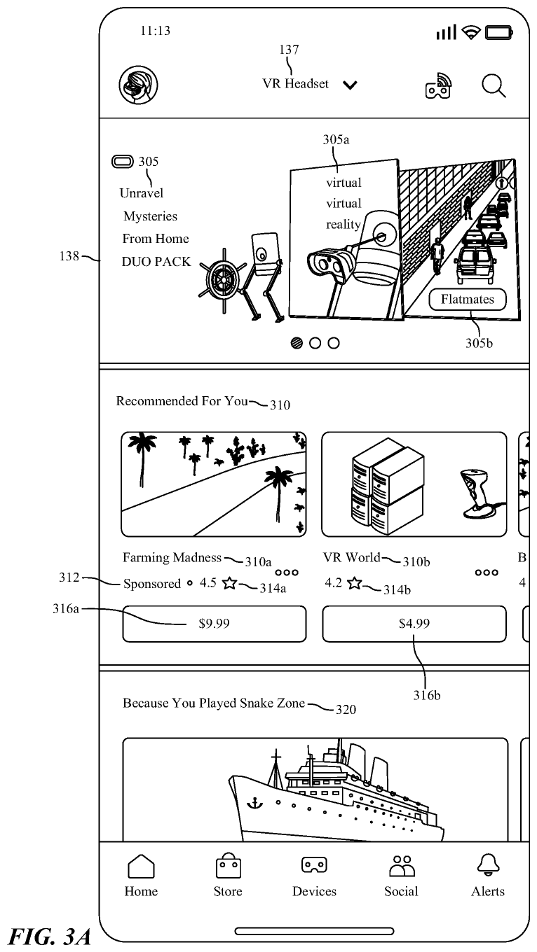

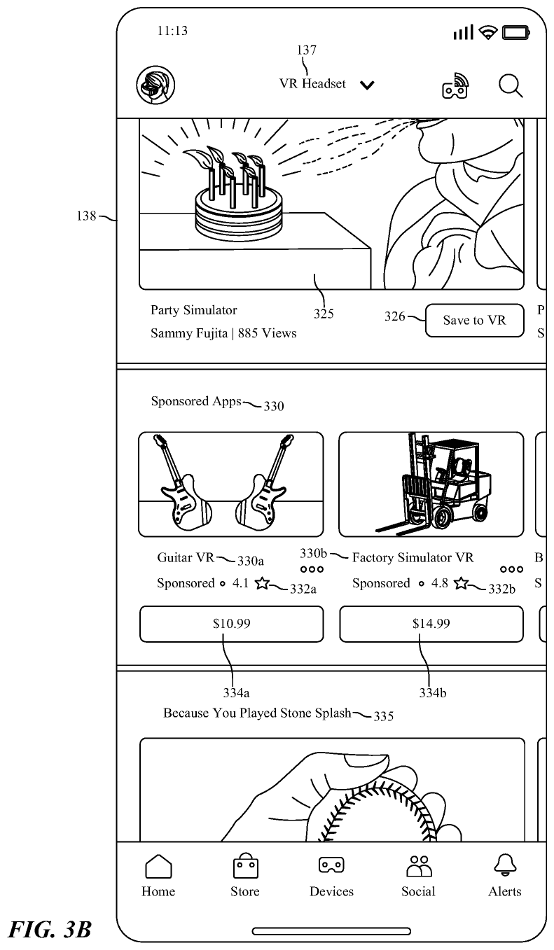

FIG. 3A illustrates an example user interface of VR content recommendation on a smart phone. On the display of the smart phone (i.e., client system 138), the user may see content recommendation for the user's VR headset (i.e., VR display device 137). The content recommendation may comprise a promotion 305 (e.g., “unravel mysteries from home duo pack”) when the user purchase two of the recommended VR applications (e.g., “virtual virtual reality” 305a) or VR games (e.g., “flatmates” 305b). The content recommendation may also comprise individually recommended VR applications or VR games 136 in the section of “recommended for you” 310. For example, these applications or games may include “farming madness” 310a, “VR world” 310b, etc. Each recommended application/game may be indicated as whether it is sponsored by a third party. For example, “farming madness” 310a is sponsored (i.e., with “sponsored” 312 being indicated). Each recommended application/game may be also associated with a rating. For example, “farming madness” 310a has a rating 314a of 4.5 whereas “VR world” 310b has a rating 314b of 4.2. The price for each recommended application/game may be displayed as well. For example, the price 316a for “farming madness” 310a is $9.99 whereas the price 316b for “VR world” 310b is $4.99. The content recommendation may further comprise recommended VR games that are selected based on the user's previous gaming history, i.e., the section of “because you played snake zone” 320.

FIG. 3B illustrates another example user interface of VR content recommendation on the smart phone. On the display of the smart phone 138, the user may see content recommendation for the user's VR headset 137. The content recommendation may comprise recommendation of free VR applications or VR games, which the user may immediately save to the user's VR headset 137 with one click. For example, one recommended VR application/game may be “party simulator” 325 and the user may click on the “save to VR” 326 button to have it downloaded to the VR headset 137. The content recommendation may also comprise sponsored VR applications or VR games in the section of “sponsored apps” 330. For example, these applications or games may include “guitar VR” 330a, “factory simulator VR” 330b, etc. Each recommended application/game may be associated with a rating. For example, “guitar VR” 330a has a rating 332a of 4.1 whereas “factory simulator VR” 330b has a rating 332b of 4.8. The price for each sponsored application/game may be displayed as well. For example, the price 334a for “guitar VR” 330a is $10.99 whereas the price 334b for “factory simulator VR” 330b is $14.99. The content recommendation may further comprise recommended VR games that are selected based on the user's previous gaming history, i.e., the section of “because you played stone splash” 335.

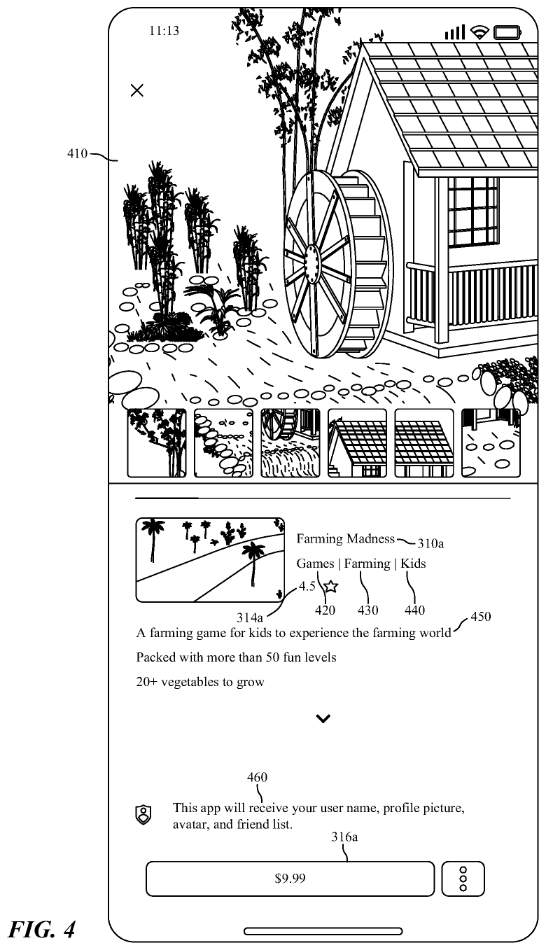

FIG. 4 illustrates an example product detail page. After the user selects a VR application/game (e.g., “farming madness” 310a in FIG. 3A), the user may be directed to the product detail page of the selected application/game. The product detail page may display visual content 410 (e.g., images) of “farming madness” 310a. The product detail page may also display the name 310a, the type 420 (e.g., games), the category 430 (e.g., farming), and the target user group 440 (e.g., kids). The product detail page may additionally show the rating 314a and a brief description 450 of the application/game. Furthermore, the product detail page may show privacy related information 460. At the bottom of the product detail page, the price 316a button may be shown. If the user clicks on the price 316a button, the user may be directed to a purchase confirmation page.

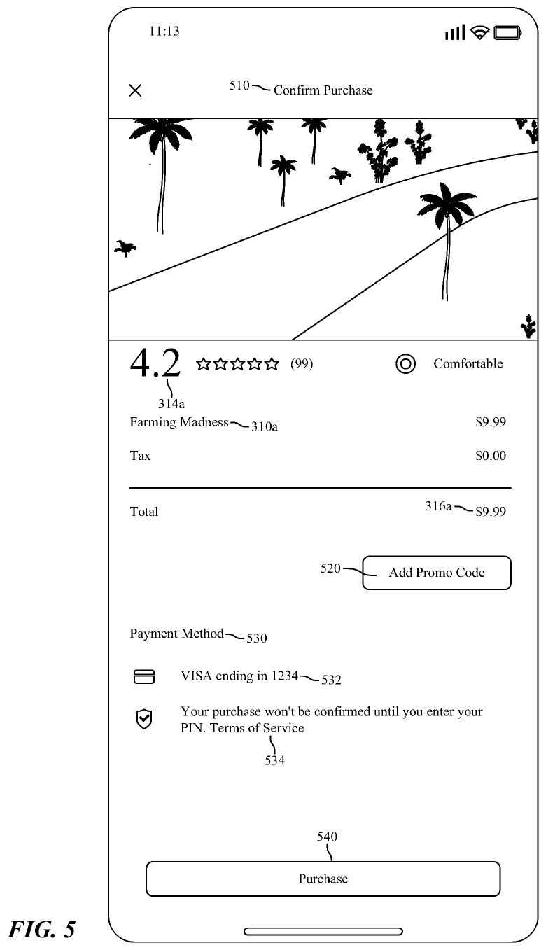

FIG. 5 illustrates an example user interface for purchase confirmation. After the user selects a VR application/game for purchase, the user may be directed to a user interface for confirmation (i.e., “confirm purchase” 510). As illustrated in FIG. 5, the selected VR application/game may be “farming madness” 310a. In the confirmation page, the user may review the name 310a, the rating 314a, and the price after tax 316a. The user may have the option to add a promotion code via the “add promo code” 520 button. The user may also review the payment method 530, which includes the card used for payment 532 and term of service 534. Once the user clicks on the “purchase” 540 button, the application/game “farming madness” 310a may be purchased and automatically downloaded to and installed on the user's VR headset.

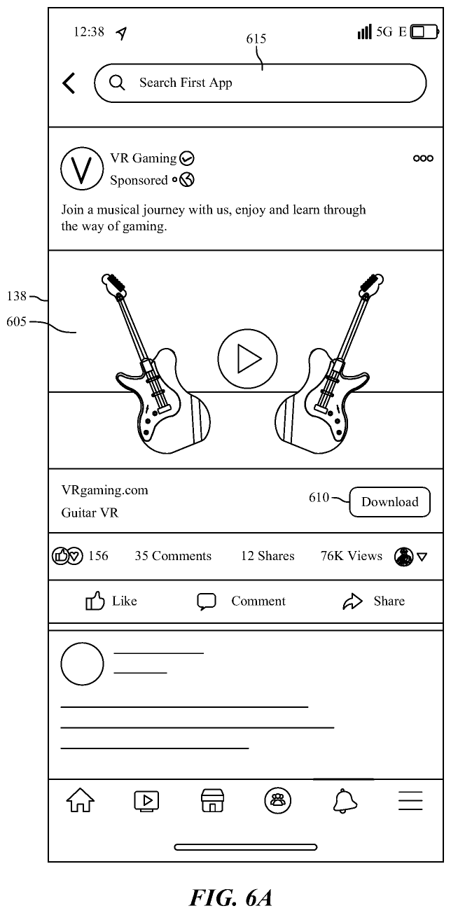

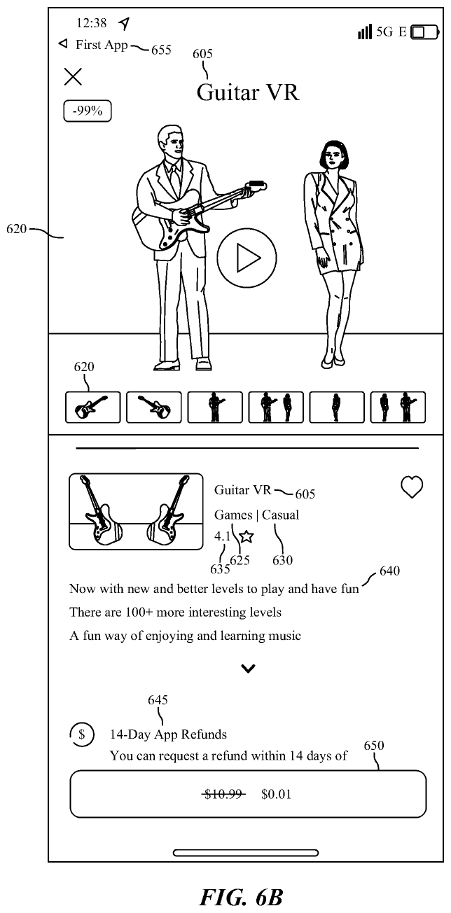

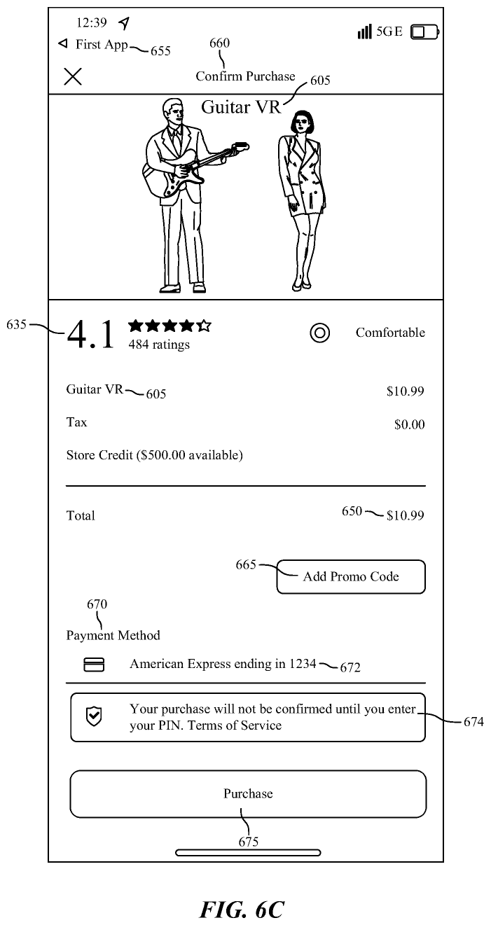

FIGS. 6A-6C illustrate example cross-platform VR application recommendation. FIG. 6A illustrates an example recommendation of a VR application/game in a non-VR application. As illustrated in FIG. 6A, a user may be using a non-VR application (e.g., “first app”) on the user's smart phone 138. The first application may be a social-networking application. The recommendation of the VR application/game (e.g., “guitar VR” 605 from “VRgaming.com”) may be shown on the user's newsfeed in the social-networking application. There may be brief descriptions, likes, comments, shares, views, etc. of the VR application/game 605 being displayed as well. The user may click on the “download” 610 button to conveniently have it downloaded to the user's VR headset. As can be seen, the user may not need to leave the first application to install the recommended VR application/game as the user may still interact with the first application for different tasks (e.g., search content within the first application using the search bar 615).

FIG. 6B illustrates an example product detail page within the non-VR application. After the user selects the recommended VR application/game 605, the user may be directed to the product detail page of the selected application/game within the first application. The product detail page may display visual content 620 (e.g., images and videos) of “guitar VR” 605. The product detail page may also display the name 605, the type 625 (e.g., games), the category 630 (e.g., casual), and the rating 635 (e.g., 4.1). The product detail page may additionally show a brief description 640 of the application/game. Furthermore, the product detail page may show the purchase terms 645. At the bottom of the product detail page, the price 650 button may be shown. If the user clicks on the price 650 button, the user may be directed to a purchase confirmation page. As can be seen, the user may easily get back to the newsfeed of the first application by clicking on the “<first app” 655.

FIG. 6C illustrates an example user interface for purchase confirmation. After the user selects a VR application/game for purchase, the user may be directed to a user interface for confirmation (i.e., “confirm purchase” 660). As illustrated in FIG. 6C, the selected VR application/game may be “guitar VR” 605. In the confirmation page, the user may review the name 605, the rating 635, and the price after tax 650. The user may have the option to add a promotion code via the “add promo code” 665 button. The user may also review the payment method 670, which includes the card used for payment 672 and term of service 674. Once the user clicks on the “purchase” 675 button, the application/game “guitar VR” 605b may be purchased and automatically downloaded to and installed on the user's VR headset. As can be seen, the user may still easily get back to the newsfeed of the first application by clicking on the “ [symbol] first app” 655.

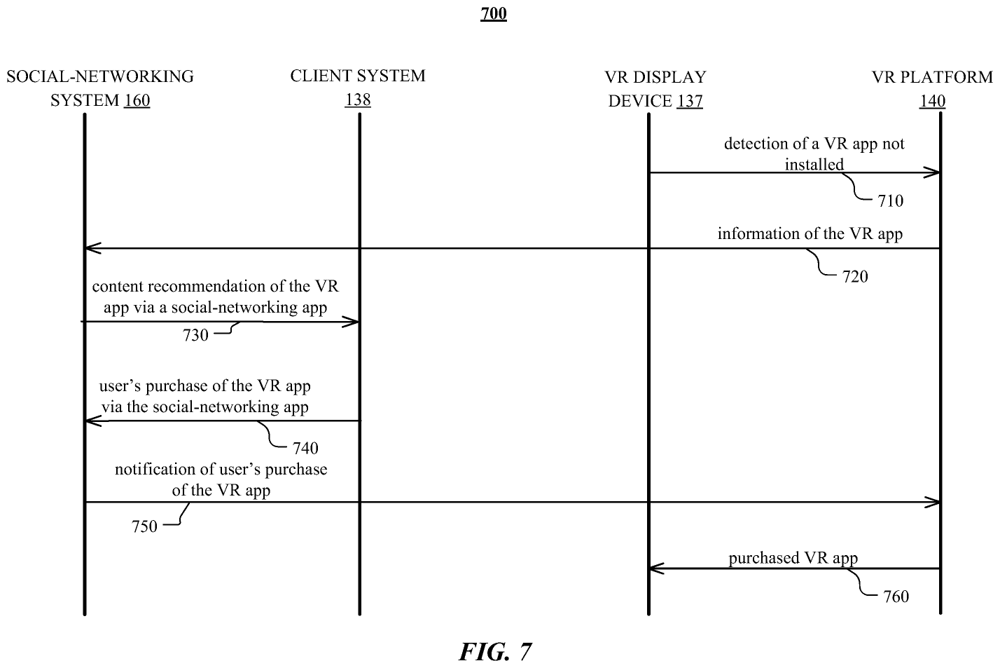

FIG. 7 illustrates an example interaction flow 700 between a social-networking system 160, a client system 138, a VR display device 137, and a VR platform 140. In particular embodiments, at step 710, the VR platform 140 may detect that a particular VR application 136 is not installed on a user's VR display device 137. Responsive to the detection, at step 720, the VR platform 140 may provide information of the VR applications 136 to the social-networking system 160. As an example and not by way of limitation, the information of the VR application 136 may include the description, the category, the target group of users, the product detail page, the price, etc. At step 730, the social-networking system 160 may send content recommendation of the VR application 136 to the user's client system 138 (e.g., a companion device of the user's VR display device 137) via a social-networking application 134. The user may interact with the content recommendation and purchase the VR application 136 via the social-networking application. Subsequently at step 740, the user's client system 138 may notify the social-networking system 160 via the social-networking application 134 about the user's purchase of the VR application 136. At step 750, the social-networking system 160 may then notify the VR platform 140 that the user has purchased the VR application 136. As a result, at step 760, the VR platform 140 may send the installation data of the purchased VR application 136 to the VR display device 137, after which the VR display device 137 may automatically install the VR application 136.

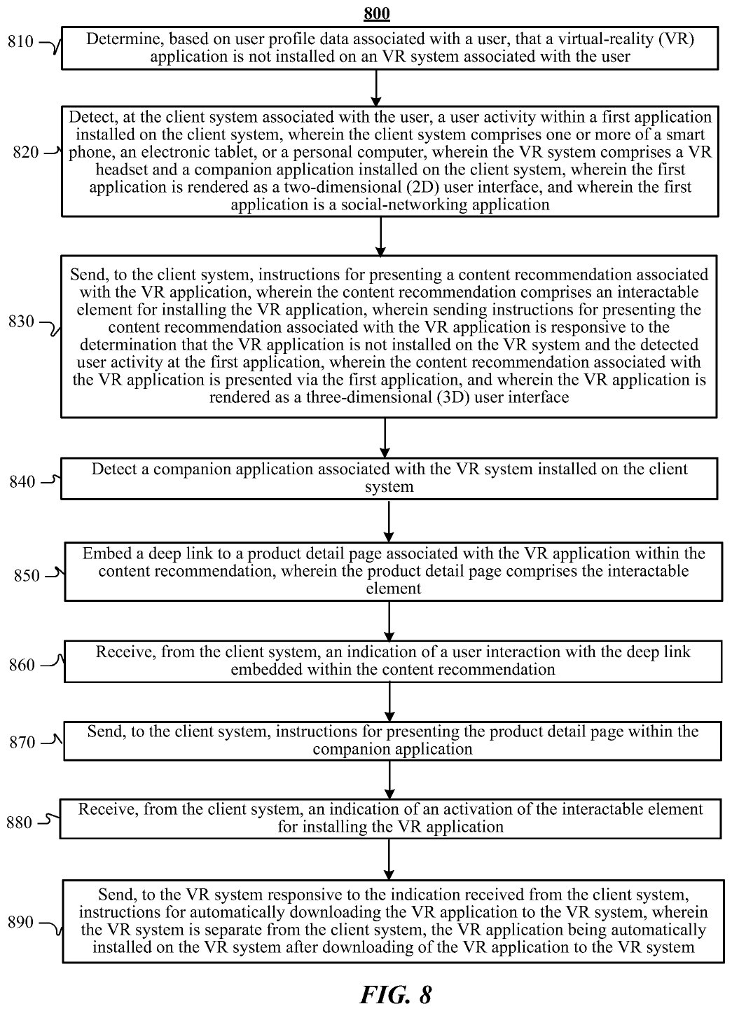

FIG. 8 illustrates an example method 800 for enabling installation of a VR application 136. The method may begin at step 810, where one or more computing systems may determine, based on user profile data associated with a user, that a virtual-reality (VR) application 136 is not installed on an VR system 130 associated with the user. At step 820, the one or more computing systems may detect, at the client system 138 associated with the user, a user activity within a first application installed on the client system 138, wherein the client system 138 comprises one or more of a smart phone, an electronic tablet, or a personal computer, wherein the VR system 130 comprises a VR headset and a companion application installed on the client system 138, wherein the first application is rendered as a two-dimensional (2D) user interface, and wherein the first application is a social-networking application 134. At step 830, the one or more computing systems may send, to the client system 138, instructions for presenting a content recommendation associated with the VR application 136, wherein the content recommendation comprises an interactable element for installing the VR application 136, wherein sending instructions for presenting the content recommendation associated with the VR application 136 is responsive to the determination that the VR application 136 is not installed on the VR system 130 and the detected user activity at the first application, wherein the content recommendation associated with the VR application 136 is presented via the first application, and wherein the VR application 136 is rendered as a three-dimensional (3D) user interface. At step 840, the one or more computing systems may detect a companion application associated with the VR system 130 installed on the client system 138. At step 850, the one or more computing systems may embed a deep link to a product detail page associated with the VR application 136 within the content recommendation, wherein the product detail page comprises the interactable element. At step 860, the one or more computing systems may receive, from the client system 138, an indication of a user interaction with the deep link embedded within the content recommendation. At step 870, the one or more computing systems may send, to the client system 138, instructions for presenting the product detail page within the companion application. At step 880, the one or more computing systems may receive, from the client system 138, an indication of an activation of the interactable element for installing the VR application 136. At step 890, the one or more computing systems may send, to the VR system 130 responsive to the indication received from the client system 138, instructions for automatically downloading the VR application 136 to the VR system 130, wherein the VR system 130 is separate from the client system 138, the VR application 136 being automatically installed on the VR system 130 after downloading of the VR application 136 to the VR system 130. Particular embodiments may repeat one or more steps of the method of FIG. 8, where appropriate. Although this disclosure describes and illustrates particular steps of the method of FIG. 8 as occurring in a particular order, this disclosure contemplates any suitable steps of the method of FIG. 8 occurring in any suitable order. Moreover, although this disclosure describes and illustrates an example method for enabling installation of a VR application including the particular steps of the method of FIG. 8, this disclosure contemplates any suitable method for enabling installation of a VR application including any suitable steps, which may include all, some, or none of the steps of the method of FIG. 8, where appropriate. Furthermore, although this disclosure describes and illustrates particular components, devices, or systems carrying out particular steps of the method of FIG. 8, this disclosure contemplates any suitable combination of any suitable components, devices, or systems carrying out any suitable steps of the method of FIG. 8.

### Advertising

In particular embodiments, an advertisement may be text (which may be HTML-linked), one or more images (which may be HTML-linked), one or more videos, audio, one or more VR renderings, other suitable digital object files, a suitable combination of these, or any other suitable advertisement in any suitable digital format presented on one or more web pages, in one or more e-mails, in one or more applications, or in connection with search results requested by a user. In addition or as an alternative, an advertisement may be one or more sponsored stories (e.g., a news-feed or ticker item on social-networking system 160). A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. The social action may be promoted within or on social-networking system &60. In addition or as an alternative, the social action may be promoted outside or off of social-networking system 160, where appropriate. In particular embodiments, a page may be an on-line presence (such as a webpage or website within or outside of social-networking system 160) of a business, organization, or brand facilitating its sharing of stories and connecting with people. A page may be customized, for example, by adding applications, posting stories, or hosting events.

A sponsored story may be generated from stories in users' news feeds and promoted to specific areas within displays of users' web browsers when viewing a web page associated with social-networking system 160. Sponsored stories are more likely to be viewed by users, at least in part because sponsored stories generally involve interactions or suggestions by the users' friends, fan pages, or other connections. In connection with sponsored stories, particular embodiments may utilize one or more systems, components, elements, functions, methods, operations, or steps disclosed in U.S. patent application Ser. No. 13/327,557, entitled “Sponsored Stories Unit Creation from Organic Activity Stream” and filed 15 Dec. 2011, U.S. Patent Application Publication No. 2012/0203831, entitled “Sponsored Stories Unit Creation from Organic Activity Stream” and filed 3 Feb. 2012 as U.S. patent application Ser. No. 13/020,745, or U.S. Patent Application Publication No. 2012/0233009, entitled “Endorsement Subscriptions for Sponsored Stories” and filed 9 Mar. 2011 as U.S. patent application Ser. No. 13/044,506, which are all incorporated herein by reference as an example and not by way of limitation. In particular embodiments, sponsored stories may utilize computer-vision algorithms to detect products in uploaded images or photos lacking an explicit connection to an advertiser as disclosed in U.S. patent application Ser. No. 13/212,356, entitled “Computer-Vision Content Detection for Sponsored Stories” and filed 18 Aug. 2011, which is incorporated herein by reference as an example and not by way of limitation.

As described above, an advertisement may be text (which may be HTML-linked), one or more images (which may be HTML-linked), one or more videos, audio, one or more VR renderings, other suitable digital object files, a suitable combination of these, or any other suitable advertisement in any suitable digital format. In particular embodiments, an advertisement may be requested for display within third-party webpages, social-networking-system webpages, or other pages. An advertisement may be displayed in a dedicated portion of a page, such as in a banner area at the top of the page, in a column at the side of the page, in a GUI of the page, in a pop-up window, over the top of content of the page, or elsewhere with respect to the page. In addition or as an alternative, an advertisement may be displayed within an application or within a game. As an example and not by way of limitation, the application may be a VR application associated with a VR system. An advertisement may be displayed within dedicated pages, requiring the user to interact with or watch the advertisement before the user may access a page, utilize an application, or play a game. The user may, for example view the advertisement through a web browser. An advertisement may be also displayed in a dedicated portion of an application, such as in a banner area at the top of the application, in a column at the side of the application, in a GUI of the application, in a pop-up window, over the top of content of the application, or elsewhere with respect to the application.

A user may interact with an advertisement in any suitable manner. The user may click or otherwise select the advertisement, and the advertisement may direct the user (or a browser or other application being used by the user) to a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio, video, or VR/AR rendering may be played by selecting a component of the advertisement (like a “play button”). In particular embodiments, an advertisement may include one or more games, which a user or other application may play in connection with the advertisement. An advertisement may include functionality for responding to a poll or question in the advertisement.

An advertisement may include social-networking-system functionality that a user may interact with. For example, an advertisement may enable a user to “like” or otherwise endorse the advertisement by selecting an icon or link associated with endorsement. Similarly, a user may share the advertisement with another user (e.g., through social-networking system 160) or RSVP (e.g., through social-networking system 160) to an event associated with the advertisement. In addition or as an alternative, an advertisement may include social-networking-system content directed to the user. For example, an advertisement may display information about a friend of the user within social-networking system 160 who has taken an action associated with the subject matter of the advertisement.

Social-networking-system functionality or content may be associated with an advertisement in any suitable manner. For example, an advertising system (which may include hardware, software, or both for receiving bids for advertisements and selecting advertisements in response) may retrieve social-networking functionality or content from social-networking system 160 and incorporate the retrieved social-networking functionality or content into the advertisement before serving the advertisement to a user. Examples of selecting and providing social-networking-system functionality or content with an advertisement are disclosed in U.S. Patent Application Publication No. 2012/0084160, entitled “Providing Social Endorsements with Online Advertising” and filed 5 Oct. 2010 as U.S. patent application Ser. No. 12/898,662, and in U.S. Patent Application Publication No. 2012/0232998, entitled “Selecting Social Endorsement Information for an Advertisement for Display to a Viewing User” and filed 8 Mar. 2011 as U.S. patent application Ser. No. 13/043,424, which are both incorporated herein by reference as examples only and not by way of limitation. Interacting with an advertisement that is associated with social-networking-system functionality or content may cause information about the interaction to be displayed in a profile page of the user in social-networking-system 160.

Particular embodiments may facilitate the delivery of advertisements to users that are more likely to find the advertisements more relevant or useful. For example, an advertiser may realize higher conversion rates (and therefore higher return on investment (ROI) from advertising) by identifying and targeting users that are more likely to find its advertisements more relevant or useful. The advertiser may use user-profile information in social-networking system 160 to identify those users. In addition or as an alternative, social-networking system 160 may use user-profile information in social-networking system 160 to identify those users for the advertiser. As examples and not by way of limitation, particular embodiments may target users with the following: invitations or suggestions of events; suggestions regarding coupons, deals, or wish-list items; suggestions regarding friends' life events; suggestions regarding groups; advertisements; or social advertisements. Such targeting may occur, where appropriate, on or within social-networking system 160, off or outside of social-networking system 160, or on mobile computing devices of users. When on or within social-networking system 160, such targeting may be directed to users' news feeds, search results, e-mail or other in-boxes, or notifications channels or may appear in particular area of web pages of social-networking system 160, such as a right-hand side of a web page in a concierge or grouper area (which may group along a right-hand rail advertisements associated with the same concept, node, or object) or a network-ego area (which may be based on what a user is viewing on the web page and a current news feed of the user). When off or outside of social-networking system 160, such targeting may be provided through a third-party website, e.g., involving an ad exchange or a social plug-in. When on a mobile computing device of a user, such targeting may be provided through push notifications to the mobile computing device.

Targeting criteria used to identify and target users may include explicit, stated user interests on social-networking system 160 or explicit connections of a user to a node, object, entity, brand, or page on social-networking system 160. In addition or as an alternative, such targeting criteria may include implicit or inferred user interests or connections (which may include analyzing a user's history, demographic, social or other activities, friends' social or other activities, subscriptions, or any of the preceding of other users similar to the user (based, e.g., on shared interests, connections, or events)). Particular embodiments may utilize platform targeting, which may involve platform and “like” impression data; contextual signals (e.g., “Who is viewing now or has viewed recently the page for [third-party brand]?”); light-weight connections (e.g., “check-ins”); connection lookalikes; fans; extracted keywords; EMU advertising; inferential advertising; coefficients, affinities, or other social-graph information; friends-of-friends connections; pinning or boosting; deals; polls; household income, social clusters or groups; products detected in images or other media; social- or open-graph edge types; geo-prediction; views of profile or pages; status updates or other user posts (analysis of which may involve natural-language processing or keyword extraction); events information; or collaborative filtering. Identifying and targeting users may also include privacy settings (such as user opt-outs), data hashing, or data anonymization, as appropriate.

To target users with advertisements, particular embodiments may utilize one or more systems, components, elements, functions, methods, operations, or steps disclosed in the following, which are all incorporated herein by reference as examples and not by way of limitation: U.S. Patent Application Publication No. 2009/0119167, entitled “Social Advertisements and Other Informational Messages on a Social Networking Website and Advertising Model for Same” and filed 18 Aug. 2008 as U.S. patent application Ser. No. 12/193,702; U.S. Patent Application Publication No. 2009/0070219, entitled “Targeting Advertisements in a Social Network” and filed 20 Aug. 2008 as U.S. patent application Ser. No. 12/195,321; U.S. Patent Application Publication No. 2012/0158501, entitled “Targeting Social Advertising to Friends of Users Who Have Interacted With an Object Associated with the Advertising” and filed 15 Dec. 2010 as U.S. patent application Ser. No. 12/968,786; or U.S. Patent Application Publication No. 2012/0166532, entitled “Contextually Relevant Affinity Prediction in a Social-Networking System” and filed 23 Dec. 2010 as U.S. patent application Ser. No. 12/978,265.

An advertisement may be presented or otherwise delivered using plug-ins for web browsers or other applications, iframe elements, news feeds, tickers, notifications (which may include, for example, e-mail, Short Message Service (SMS) messages, or notifications), or other means. An advertisement may be presented or otherwise delivered to a user on a mobile or other computing device (e.g., a VR headset) of the user. In connection with delivering advertisements, particular embodiments may utilize one or more systems, components, elements, functions, methods, operations, or steps disclosed in the following, which are all incorporated herein by reference as examples and not by way of limitation: U.S. Patent Application Publication No. 2012/0159635, entitled “Comment Plug-In for Third-Party System” and filed 15 Dec. 2010 as U.S. patent application Ser. No. 12/969,368; U.S. Patent Application Publication No. 2012/0158753, entitled “Comment Ordering System” and filed 15 Dec. 2010 as U.S. patent application Ser. No. 12/969,408; U.S. Pat. No. 7,669,123, entitled “Dynamically Providing a News Feed About a User of a Social Network” and filed 11 Aug. 2006 as U.S. patent application Ser. No. 11/503,242; U.S. Pat. No. 8,402,094, entitled “Providing a Newsfeed Based on User Affinity for Entities and Monitored Actions in a Social Network Environment” and filed 11 Aug. 2006 as U.S. patent application Ser. No. 11/503,093; U.S. Patent Application Publication No. 2012/0072428, entitled “Action Clustering for News Feeds” and filed 16 Sep. 2010 as U.S. patent application Ser. No. 12/884,010; U.S. Patent Application Publication No. 2011/0004692, entitled “Gathering Information about Connections in a Social Networking Service” and filed 1 Jul. 2009 as U.S. patent application Ser. No. 12/496,606; U.S. Patent Application Publication No. 2008/0065701, entitled “Method and System for Tracking Changes to User Content in an Online Social Network” and filed 12 Sep. 2006 as U.S. patent application Ser. No. 11/531,154; U.S. Patent Application Publication No. 2008/0065604, entitled “Feeding Updates to Landing Pages of Users of an Online Social Network from External Sources” and filed 17 Jan. 2007 as U.S. patent application Ser. No. 11/624,088; U.S. Pat. No. 8,244,848, entitled “Integrated Social-Network Environment” and filed 19 Apr. 2010 as U.S. patent application Ser. No. 12/763,171; U.S. Patent Application Publication No. 2011/0083101, entitled “Sharing of Location-Based Content Item in Social-Networking Service” and filed 6 Oct. 2009 as U.S. patent application Ser. No. 12/574,614; U.S. Pat. No. 8,150,844, entitled “Location Ranking Using Social-Graph Information” and filed 18 Aug. 2010 as U.S. patent application Ser. No. 12/858,718; U.S. patent application Ser. No. 13/051,286, entitled “Sending Notifications to Users Based on Users' Notification Tolerance Levels” and filed 18 Mar. 2011; U.S. patent application Ser. No. 13/096,184, entitled “Managing Notifications Pushed to User Devices” and filed 28 Apr. 2011; U.S. patent application Ser. No. 13/276,248, entitled “Platform-Specific Notification Delivery Channel” and filed 18 Oct. 2011; or U.S. Patent Application Publication No. 2012/0197709, entitled “Mobile Advertisement with Social Component for Geo-Social Networking System” and filed 1 Feb. 2011 as U.S. patent application Ser. No. 13/019,061. Although this disclosure describes or illustrates particular advertisements being delivered in particular ways and in connection with particular content, this disclosure contemplates any suitable advertisements delivered in any suitable ways and in connection with any suitable content.

### Social Graphs

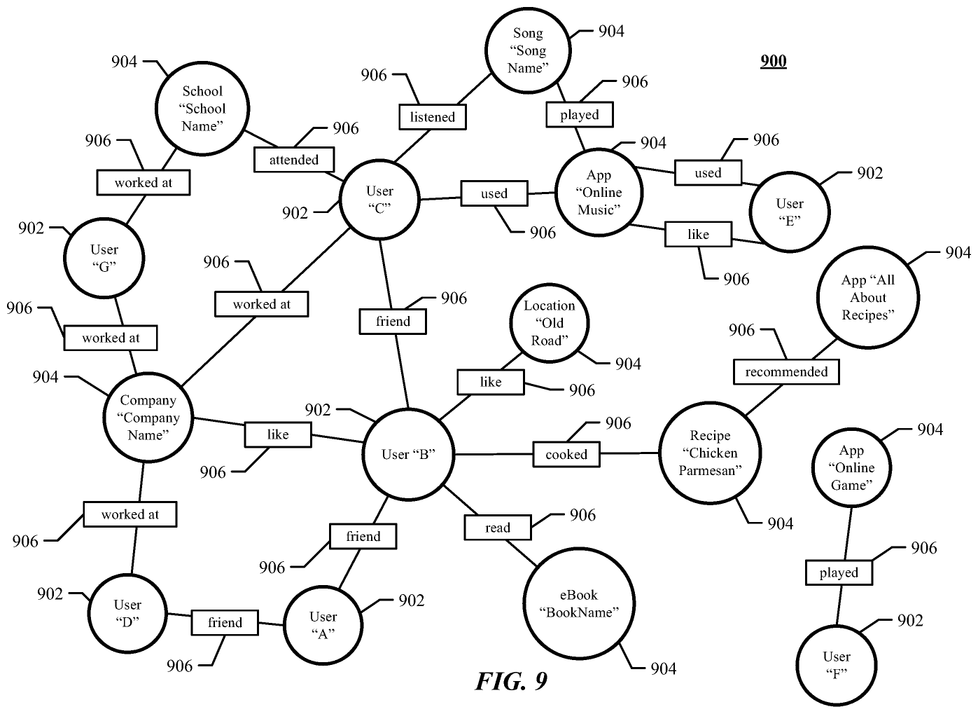

FIG. 9 illustrates an example social graph 900. In particular embodiments, the social-networking system 160 may store one or more social graphs 900 in one or more data stores. In particular embodiments, the social graph 900 may include multiple nodes—which may include multiple user nodes 902 or multiple concept nodes 904—and multiple edges 906 connecting the nodes. Each node may be associated with a unique entity (i.e., user or concept), each of which may have a unique identifier (ID), such as a unique number or username. The example social graph 900 illustrated in FIG. 9 is shown, for didactic purposes, in a two-dimensional visual map representation. In particular embodiments, a social-networking system 160, a VR system 130, a VR platform 140, or a third-party system 170 may access the social graph 900 and related social-graph information for suitable applications. The nodes and edges of the social graph 900 may be stored as data objects, for example, in a data store (such as a social-graph database). Such a data store may include one or more searchable or queryable indexes of nodes or edges of the social graph 900.

In particular embodiments, a user node 902 may correspond to a user of the social-networking system 160 or the VR platform 140. As an example and not by way of limitation, a user may be an individual (human user), an entity (e.g., an enterprise, business, or third-party application), or a group (e.g., of individuals or entities) that interacts or communicates with or over the social-networking system 160 or the VR platform 140. In particular embodiments, when a user registers for an account with the social-networking system 160, the social-networking system 160 may create a user node 902 corresponding to the user, and store the user node 902 in one or more data stores. Users and user nodes 902 described herein may, where appropriate, refer to registered users and user nodes 902 associated with registered users. In addition or as an alternative, users and user nodes 902 described herein may, where appropriate, refer to users that have not registered with the social-networking system 160. In particular embodiments, a user node 902 may be associated with information provided by a user or information gathered by various systems, including the social-networking system 160. As an example and not by way of limitation, a user may provide his or her name, profile picture, contact information, birth date, sex, marital status, family status, employment, education background, preferences, interests, or other demographic information. In particular embodiments, a user node 902 may be associated with one or more data objects corresponding to information associated with a user. In particular embodiments, a user node 902 may correspond to one or more web interfaces.

In particular embodiments, a concept node 904 may correspond to a concept. As an example and not by way of limitation, a concept may correspond to a place (such as, for example, a movie theater, restaurant, landmark, or city); a website (such as, for example, a website associated with the social-networking system 160 or a third-party website associated with a web-application server); an entity (such as, for example, a person, business, group, sports team, or celebrity); a resource (such as, for example, an audio file, video file, digital photo, text file, structured document, or application) which may be located within the social-networking system 160 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 904 may be associated with information of a concept provided by a user or information gathered by various systems, including the social-networking system 160 and the VR platform 140. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 904 may be associated with one or more data objects corresponding to information associated with concept node 904. In particular embodiments, a concept node 904 may correspond to one or more web interfaces.

In particular embodiments, a node in the social graph 900 may represent or be represented by a web interface (which may be referred to as a “profile interface”). Profile interfaces may be hosted by or accessible to the social-networking system 160 or the VR platform 140. Profile interfaces may also be hosted on third-party websites associated with a third-party system 170. As an example and not by way of limitation, a profile interface corresponding to a particular external web interface may be the particular external web interface and the profile interface may correspond to a particular concept node 904. Profile interfaces may be viewable by all or a selected subset of other users. As an example and not by way of limitation, a user node 902 may have a corresponding user-profile interface in which the corresponding user may add content, make declarations, or otherwise express himself or herself. As another example and not by way of limitation, a concept node 904 may have a corresponding concept-profile interface in which one or more users may add content, make declarations, or express themselves, particularly in relation to the concept corresponding to concept node 904.

In particular embodiments, a concept node 904 may represent a third-party web interface or resource hosted by a third-party system 170. The third-party web interface or resource may include, among other elements, content, a selectable or other icon, or other inter-actable object representing an action or activity. As an example and not by way of limitation, a third-party web interface may include a selectable icon such as “like,” “check-in,” “eat,” “recommend,” or another suitable action or activity. A user viewing the third-party web interface may perform an action by selecting one of the icons (e.g., “check-in”), causing a VR system 130 to send to the social-networking system 160 a message indicating the user's action. In response to the message, the social-networking system 160 may create an edge (e.g., a check-in-type edge) between a user node 902 corresponding to the user and a concept node 904 corresponding to the third-party web interface or resource and store edge 906 in one or more data stores.

In particular embodiments, a pair of nodes in the social graph 900 may be connected to each other by one or more edges 906. An edge 906 connecting a pair of nodes may represent a relationship between the pair of nodes. In particular embodiments, an edge 906 may include or represent one or more data objects or attributes corresponding to the relationship between a pair of nodes. As an example and not by way of limitation, a first user may indicate that a second user is a “friend” of the first user. In response to this indication, the social-networking system 160 may send a “friend request” to the second user. If the second user confirms the “friend request,” the social-networking system 160 may create an edge 906 connecting the first user's user node 902 to the second user's user node 902 in the social graph 900 and store edge 906 as social-graph information in one or more of data stores 164. In the example of FIG. 9, the social graph 900 includes an edge 906 indicating a friend relation between user nodes 902 of user “A” and user “B” and an edge indicating a friend relation between user nodes 902 of user “C” and user “B.” Although this disclosure describes or illustrates particular edges 906 with particular attributes connecting particular user nodes 902, this disclosure contemplates any suitable edges 906 with any suitable attributes connecting user nodes 902. As an example and not by way of limitation, an edge 906 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in the social graph 900 by one or more edges 906. The degree of separation between two objects represented by two nodes, respectively, is a count of edges in a shortest path connecting the two nodes in the social graph 900. As an example and not by way of limitation, in the social graph 900, the user node 902 of user “C” is connected to the user node 902 of user “A” via multiple paths including, for example, a first path directly passing through the user node 902 of user “B,” a second path passing through the concept node 904 of company “CompanyName” and the user node 902 of user “D,” and a third path passing through the user nodes 902 and concept nodes 904 representing school “SchoolName,” user “G,” company “CompanyName,” and user “D.” User “C” and user “A” have a degree of separation of two because the shortest path connecting their corresponding nodes (i.e., the first path) includes two edges 906.

In particular embodiments, an edge 906 between a user node 902 and a concept node 904 may represent a particular action or activity performed by a user associated with user node 902 toward a concept associated with a concept node 904. As an example and not by way of limitation, as illustrated in FIG. 9, a user may “like,” “attended,” “played,” “listened,” “cooked,” “worked at,” or “read” a concept, each of which may correspond to an edge type or subtype. A concept-profile interface corresponding to a concept node 904 may include, for example, a selectable “check in” icon (such as, for example, a clickable “check in” icon) or a selectable “add to favorites” icon. Similarly, after a user clicks these icons, the social-networking system 160 may create a “favorite” edge or a “check in” edge in response to a user's action corresponding to a respective action. As another example and not by way of limitation, a user (user “C”) may listen to a particular song (“SongName”) using a particular application (a third-party online music application). In this case, the social-networking system 160 may create a “listened” edge 906 and a “used” edge (as illustrated in FIG. 9) between user nodes 902 corresponding to the user and concept nodes 904 corresponding to the song and application to indicate that the user listened to the song and used the application. Moreover, the social-networking system 160 may create a “played” edge 906 (as illustrated in FIG. 9) between concept nodes 904 corresponding to the song and the application to indicate that the particular song was played by the particular application. In this case, “played” edge 906 corresponds to an action performed by an external application (the third-party online music application) on an external audio file (the song “SongName”). Although this disclosure describes particular edges 906 with particular attributes connecting user nodes 902 and concept nodes 904, this disclosure contemplates any suitable edges 906 with any suitable attributes connecting user nodes 902 and concept nodes 904. Moreover, although this disclosure describes edges between a user node 902 and a concept node 904 representing a single relationship, this disclosure contemplates edges between a user node 902 and a concept node 904 representing one or more relationships. As an example and not by way of limitation, an edge 906 may represent both that a user likes and has used at a particular concept. Alternatively, another edge 906 may represent each type of relationship (or multiples of a single relationship) between a user node 902 and a concept node 904 (as illustrated in FIG. 9 between user node 902 for user “E” and concept node 904 for “online music application”).

In particular embodiments, the social-networking system 160 may create an edge 906 between a user node 902 and a concept node 904 in the social graph 900. As an example and not by way of limitation, a user viewing a concept-profile interface (such as, for example, by using a web browser or a special-purpose application hosted by the user's VR system 130) may indicate that he or she likes the concept represented by the concept node 904 by clicking or selecting a “Like” icon, which may cause the user's VR system 130 to send to the social-networking system 160 a message indicating the user's liking of the concept associated with the concept-profile interface. In response to the message, the social-networking system 160 may create an edge 906 between user node 902 associated with the user and concept node 904, as illustrated by “like” edge 906 between the user and concept node 904. In particular embodiments, the social-networking system 160 may store an edge 906 in one or more data stores. In particular embodiments, an edge 906 may be automatically formed by the social-networking system 160 in response to a particular user action. As an example and not by way of limitation, if a first user uploads a picture, reads a book, watches a movie, or listens to a song, an edge 906 may be formed between user node 902 corresponding to the first user and concept nodes 904 corresponding to those concepts. Although this disclosure describes forming particular edges 906 in particular manners, this disclosure contemplates forming any suitable edges 906 in any suitable manner.

### Privacy

In particular embodiments, one or more objects (e.g., content or other types of objects) of a computing system may be associated with one or more privacy settings. The one or more objects may be stored on or otherwise associated with any suitable computing system or application, such as, for example, a social-networking system 160, a VR system 130, a VR platform 140, a third-party system 170, a social-networking application 134, a VR application 136, a messaging application, a photo-sharing application, or any other suitable computing system or application. Although the examples discussed herein are in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular embodiments, privacy settings for an object may specify a “blocked list” of users or other entities that should not be allowed to access certain information associated with the object. In particular embodiments, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular embodiments, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular photo may have a privacy setting specifying that the photo may be accessed only by users tagged in the photo and friends of the users tagged in the photo. In particular embodiments, privacy settings may allow users to opt in to or opt out of having their content, information, or actions stored/logged by the social-networking system 160 or VR platform 140 or shared with other systems (e.g., a third-party system 170). Although this disclosure describes using particular privacy settings in a particular manner, this disclosure contemplates using any suitable privacy settings in any suitable manner.

In particular embodiments, privacy settings may be based on one or more nodes or edges of a social graph 800. A privacy setting may be specified for one or more edges 806 or edge-types of the social graph 800, or with respect to one or more nodes 802, 804 or node-types of the social graph 800. The privacy settings applied to a particular edge 806 connecting two nodes may control whether the relationship between the two entities corresponding to the nodes is visible to other users of the online social network. Similarly, the privacy settings applied to a particular node may control whether the user or concept corresponding to the node is visible to other users of the online social network. As an example and not by way of limitation, a first user may share an object to the social-networking system 160. The object may be associated with a concept node 804 connected to a user node 802 of the first user by an edge 806. The first user may specify privacy settings that apply to a particular edge 806 connecting to the concept node 804 of the object, or may specify privacy settings that apply to all edges 806 connecting to the concept node 804. As another example and not by way of limitation, the first user may share a set of objects of a particular object-type (e.g., a set of images). The first user may specify privacy settings with respect to all objects associated with the first user of that particular object-type as having a particular privacy setting (e.g., specifying that all images posted by the first user are visible only to friends of the first user and/or users tagged in the images).

In particular embodiments, the social-networking system 160 or VR platform 140 may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular embodiments, the social-networking system 160 or VR platform 140 may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems 170, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular embodiments, one or more servers 162 may be authorization/privacy servers for enforcing privacy settings. In response to a request from a user (or other entity) for a particular object stored in a data store 164, the social-networking system 160 may send a request to the data store 164 for the object. The request may identify the user associated with the request and the object may be sent only to the user (or a VR system 130 of the user) if the authorization server determines that the user is authorized to access the object based on the privacy settings associated with the object. If the requesting user is not authorized to access the object, the authorization server may prevent the requested object from being retrieved from the data store 164 or may prevent the requested object from being sent to the user. In the search-query context, an object may be provided as a search result only if the querying user is authorized to access the object, e.g., if the privacy settings for the object allow it to be surfaced to, discovered by, or otherwise visible to the querying user. In particular embodiments, an object may represent content that is visible to a user through a newsfeed of the user. As an example and not by way of limitation, one or more objects may be visible to a user's “Trending” page. In particular embodiments, an object may correspond to a particular user. The object may be content associated with the particular user, or may be the particular user's account or information stored on the social-networking system 160, or other computing system. As an example and not by way of limitation, a first user may view one or more second users of an online social network through a “People You May Know” function of the online social network, or by viewing a list of friends of the first user. As an example and not by way of limitation, a first user may specify that they do not wish to see objects associated with a particular second user in their newsfeed or friends list. If the privacy settings for the object do not allow it to be surfaced to, discovered by, or visible to the user, the object may be excluded from the search results. Although this disclosure describes enforcing privacy settings in a particular manner, this disclosure contemplates enforcing privacy settings in any suitable manner.

In particular embodiments, different objects of the same type associated with a user may have different privacy settings. Different types of objects associated with a user may have different types of privacy settings. As an example and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In particular embodiments, different privacy settings may be provided for different user groups or user demographics. As an example and not by way of limitation, a first user may specify that other users who attend the same university as the first user may view the first user's pictures, but that other users who are family members of the first user may not view those same pictures.

In particular embodiments, the social-networking system 160 may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular embodiments, privacy settings may allow a first user to specify (e.g., by opting out, by not opting in) whether the social-networking system 160 or VR platform 140 may receive, collect, log, or store particular objects or information associated with the user for any purpose. In particular embodiments, privacy settings may allow the first user to specify whether particular applications or processes may access, store, or use particular objects or information associated with the user. The privacy settings may allow the first user to opt in or opt out of having objects or information accessed, stored, or used by specific applications or processes. The social-networking system 160 or VR platform 140 may access such information in order to provide a particular function or service to the first user, without the social-networking system 160 or VR platform 140 having access to that information for any other purposes. Before accessing, storing, or using such objects or information, the social-networking system 160 or VR platform 140 may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the social-networking system 160 or VR platform 140.

In particular embodiments, a user may specify whether particular types of objects or information associated with the first user may be accessed, stored, or used by the social-networking system 160 or VR platform 140. As an example and not by way of limitation, the first user may specify that images sent by the first user through the social-networking system 160 or VR platform 140 may not be stored by the social-networking system 160 or VR platform 140. As another example and not by way of limitation, a first user may specify that messages sent from the first user to a particular second user may not be stored by the social-networking system 160 or VR platform 140. As yet another example and not by way of limitation, a first user may specify that all objects sent via a particular application may be saved by the social-networking system 160 or VR platform 140.

In particular embodiments, privacy settings may allow a first user to specify whether particular objects or information associated with the first user may be accessed from particular VR systems 130 or third-party systems 170. The privacy settings may allow the first user to opt in or opt out of having objects or information accessed from a particular device (e.g., the phone book on a user's smart phone), from a particular application (e.g., a messaging app), or from a particular system (e.g., an email server). The social-networking system 160 or VR platform 140 may provide default privacy settings with respect to each device, system, or application, and/or the first user may be prompted to specify a particular privacy setting for each context. As an example and not by way of limitation, the first user may utilize a location-services feature of the social-networking system 160 or VR platform 140 to provide recommendations for restaurants or other places in proximity to the user. The first user's default privacy settings may specify that the social-networking system 160 or VR platform 140 may use location information provided from a VR system 130 of the first user to provide the location-based services, but that the social-networking system 160 or VR platform 140 may not store the location information of the first user or provide it to any third-party system 170. The first user may then update the privacy settings to allow location information to be used by a third-party image-sharing application in order to geo-tag photos.

In particular embodiments, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

In particular embodiments, the social-networking system 160 or VR platform 140 may have functionalities that may use, as inputs, personal or biometric information of a user for user-authentication or experience-personalization purposes. A user may opt to make use of these functionalities to enhance their experience on the online social network. As an example and not by way of limitation, a user may provide personal or biometric information to the social-networking system 160 or VR platform 140. The user's privacy settings may specify that such information may be used only for particular processes, such as authentication, and further specify that such information may not be shared with any third-party system 170 or used for other processes or applications associated with the social-networking system 160 or VR platform 140. As another example and not by way of limitation, the social-networking system 160 may provide a functionality for a user to provide voice-print recordings to the online social network. As an example and not by way of limitation, if a user wishes to utilize this function of the online social network, the user may provide a voice recording of his or her own voice to provide a status update on the online social network. The recording of the voice-input may be compared to a voice print of the user to determine what words were spoken by the user. The user's privacy setting may specify that such voice recording may be used only for voice-input purposes (e.g., to authenticate the user, to send voice messages, to improve voice recognition in order to use voice-operated features of the online social network), and further specify that such voice recording may not be shared with any third-party system 170 or used by other processes or applications associated with the social-networking system 160.

### Systems and Methods

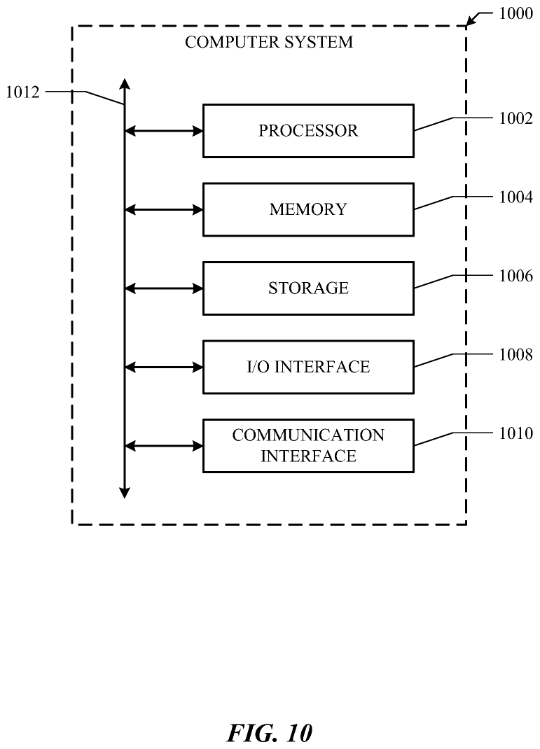

FIG. 10 illustrates an example computer system 1000. In particular embodiments, one or more computer systems 1000 perform one or more steps of one or more methods described or illustrated herein. In particular embodiments, one or more computer systems 1000 provide functionality described or illustrated herein. In particular embodiments, software running on one or more computer systems 1000 performs one or more steps of one or more methods described or illustrated herein or provides functionality described or illustrated herein. Particular embodiments include one or more portions of one or more computer systems 1000. Herein, reference to a computer system may encompass a computing device, and vice versa, where appropriate. Moreover, reference to a computer system may encompass one or more computer systems, where appropriate.

This disclosure contemplates any suitable number of computer systems 1000. This disclosure contemplates computer system 1000 taking any suitable physical form. As example and not by way of limitation, computer system 1000 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 1000 may include one or more computer systems 1000; be unitary or distributed; span multiple locations; span multiple machines; span multiple data centers; or reside in a cloud, which may include one or more cloud components in one or more networks. Where appropriate, one or more computer systems 1000 may perform without substantial spatial or temporal limitation one or more steps of one or more methods described or illustrated herein. As an example and not by way of limitation, one or more computer systems 1000 may perform in real time or in batch mode one or more steps of one or more methods described or illustrated herein. One or more computer systems 1000 may perform at different times or at different locations one or more steps of one or more methods described or illustrated herein, where appropriate.

In particular embodiments, computer system 1000 includes a processor 1002, memory 1004, storage 1006, an input/output (I/O) interface 1008, a communication interface 1010, and a bus 1012. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1002 includes hardware for executing instructions, such as those making up a computer program. As an example and not by way of limitation, to execute instructions, processor 1002 may retrieve (or fetch) the instructions from an internal register, an internal cache, memory 1004, or storage 1006; decode and execute them; and then write one or more results to an internal register, an internal cache, memory 1004, or storage 1006. In particular embodiments, processor 1002 may include one or more internal caches for data, instructions, or addresses. This disclosure contemplates processor 1002 including any suitable number of any suitable internal caches, where appropriate. As an example and not by way of limitation, processor 1002 may include one or more instruction caches, one or more data caches, and one or more translation lookaside buffers (TLBs). Instructions in the instruction caches may be copies of instructions in memory 1004 or storage 1006, and the instruction caches may speed up retrieval of those instructions by processor 1002. Data in the data caches may be copies of data in memory 1004 or storage 1006 for instructions executing at processor 1002 to operate on; the results of previous instructions executed at processor 1002 for access by subsequent instructions executing at processor 1002 or for writing to memory 1004 or storage 1006; or other suitable data. The data caches may speed up read or write operations by processor 1002. The TLBs may speed up virtual-address translation for processor 1002. In particular embodiments, processor 1002 may include one or more internal registers for data, instructions, or addresses. This disclosure contemplates processor 1002 including any suitable number of any suitable internal registers, where appropriate. Where appropriate, processor 1002 may include one or more arithmetic logic units (ALUs); be a multi-core processor; or include one or more processors 1002. Although this disclosure describes and illustrates a particular processor, this disclosure contemplates any suitable processor.

In particular embodiments, memory 1004 includes main memory for storing instructions for processor 1002 to execute or data for processor 1002 to operate on. As an example and not by way of limitation, computer system 1000 may load instructions from storage 1006 or another source (such as, for example, another computer system 1000) to memory 1004. Processor 1002 may then load the instructions from memory 1004 to an internal register or internal cache. To execute the instructions, processor 1002 may retrieve the instructions from the internal register or internal cache and decode them. During or after execution of the instructions, processor 1002 may write one or more results (which may be intermediate or final results) to the internal register or internal cache. Processor 1002 may then write one or more of those results to memory 1004. In particular embodiments, processor 1002 executes only instructions in one or more internal registers or internal caches or in memory 1004 (as opposed to storage 1006 or elsewhere) and operates only on data in one or more internal registers or internal caches or in memory 1004 (as opposed to storage 1006 or elsewhere). One or more memory buses (which may each include an address bus and a data bus) may couple processor 1002 to memory 1004. Bus 1012 may include one or more memory buses, as described below. In particular embodiments, one or more memory management units (MMUs) reside between processor 1002 and memory 1004 and facilitate accesses to memory 1004 requested by processor 1002. In particular embodiments, memory 1004 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1004 may include one or more memories 1004, where appropriate. Although this disclosure describes and illustrates particular memory, this disclosure contemplates any suitable memory.

In particular embodiments, storage 1006 includes mass storage for data or instructions. As an example and not by way of limitation, storage 1006 may include a hard disk drive (HDD), a floppy disk drive, flash memory, an optical disc, a magneto-optical disc, magnetic tape, or a Universal Serial Bus (USB) drive or a combination of two or more of these. Storage 1006 may include removable or non-removable (or fixed) media, where appropriate. Storage 1006 may be internal or external to computer system 1000, where appropriate. In particular embodiments, storage 1006 is non-volatile, solid-state memory. In particular embodiments, storage 1006 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1006 taking any suitable physical form. Storage 1006 may include one or more storage control units facilitating communication between processor 1002 and storage 1006, where appropriate. Where appropriate, storage 1006 may include one or more storages 1006. Although this disclosure describes and illustrates particular storage, this disclosure contemplates any suitable storage.

In particular embodiments, I/O interface 1008 includes hardware, software, or both, providing one or more interfaces for communication between computer system 1000 and one or more I/O devices. Computer system 1000 may include one or more of these I/O devices, where appropriate. One or more of these I/O devices may enable communication between a person and computer system 1000. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1008 for them. Where appropriate, I/O interface 1008 may include one or more device or software drivers enabling processor 1002 to drive one or more of these I/O devices. I/O interface 1008 may include one or more I/O interfaces 1008, where appropriate. Although this disclosure describes and illustrates a particular I/O interface, this disclosure contemplates any suitable I/O interface.

In particular embodiments, communication interface 1010 includes hardware, software, or both providing one or more interfaces for communication (such as, for example, packet-based communication) between computer system 1000 and one or more other computer systems 1000 or one or more networks. As an example and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1010 for it. As an example and not by way of limitation, computer system 1000 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1000 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1000 may include any suitable communication interface 1010 for any of these networks, where appropriate. Communication interface 1010 may include one or more communication interfaces 1010, where appropriate. Although this disclosure describes and illustrates a particular communication interface, this disclosure contemplates any suitable communication interface.

In particular embodiments, bus 1012 includes hardware, software, or both coupling components of computer system 1000 to each other. As an example and not by way of limitation, bus 1012 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1012 may include one or more buses 1012, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

### MISCELLANEOUS

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by one or more computing systems:
sending, to a client system associated with a user, instructions for presenting a content recommendation associated with a virtual-reality (VR) application, wherein the content recommendation comprises an interactable element for installing the VR application;
receiving, from the client system, an indication of an activation of the interactable element for installing the VR application; and
sending, to a VR system associated with the user responsive to the indication received from the client system, instructions for automatically downloading the VR application to the VR system, wherein the VR system is separate from the client system, the VR application being automatically installed on the VR system after downloading of the VR application to the VR system.

2. The method of claim 1, wherein the content recommendation associated with the VR application is presented via a first application installed on the client system.

3. The method of claim 2, further comprising:
detecting, at the client system, a user activity within the first application installed on the client system, wherein sending instructions for presenting the content recommendation associated with the VR application is responsive to the detected user activity at the first application.

4. The method of claim 2, wherein the first application is rendered as a two-dimensional (2D) user interface.

5. The method of claim 2, wherein the first application is a social-networking application.

6. The method of claim 2, further comprising:
determining a companion application associated with the VR system not installed on the client system;
embedding a URL link to a product detail page associated with the VR application within the content recommendation, wherein the product detail page comprises the interactable element;
receiving, from the client system, an indication of a user interaction with the URL link embedded within the content recommendation; and
sending, to the client system, instructions for directing the user to the product detail page via a web browser.

7. The method of claim 1, wherein the client system comprises one or more of a smart phone, an electronic tablet, or a personal computer.

8. The method of claim 1, wherein the VR system comprises a VR headset and a companion application installed on the client system.

9. The method of claim 1, wherein the VR application is rendered as a three-dimensional (3D) user interface.

10. The method of claim 1, further comprising:
detecting a companion application associated with the VR system installed on the client system;
embedding a deep link to a product detail page associated with the VR application within the content recommendation, wherein the product detail page comprises the interactable element;
receiving, from the client system, an indication of a user interaction with the deep link embedded within the content recommendation; and
sending, to the client system, instructions for presenting the product detail page within the companion application.

11. The method of claim 1, further comprising:
determining, based on user profile data associated with the user, that the VR application is not installed on the VR system associated with the user, wherein sending instructions for presenting the content recommendation associated with the VR application is responsive to the determination.

12. One or more computer-readable non-transitory storage media embodying software that is operable when executed to:
send, to a client system associated with a user, instructions for presenting a content recommendation associated with a virtual-reality (VR) application, wherein the content recommendation comprises an interactable element for installing the VR application;
receive, from the client system, an indication of an activation of the interactable element for installing the VR application; and
send, to a VR system associated with the user responsive to the indication received from the client system, instructions for automatically downloading the VR application to the VR system, wherein the VR system is separate from the client system, the VR application being automatically installed on the VR system after downloading of the VR application to the VR system.

13. The media of claim 12, wherein the content recommendation associated with the VR application is presented via a first application installed on the client system.

14. The media of claim 13, wherein the software is further operable when executed to:
detect, at the client system, a user activity within the first application installed on the client system, wherein sending instructions for presenting the content recommendation associated with the VR application is responsive to the detected user activity at the first application.

15. The media of claim 13, wherein the software is further operable when executed to:
determine a companion application associated with the VR system not installed on the client system;
embed a URL link to a product detail page associated with the VR application within the content recommendation, wherein the product detail page comprises the interactable element;
receive, from the client system, an indication of a user interaction with the URL link embedded within the content recommendation; and
send, to the client system, instructions for directing the user to the product detail page via a web browser.

16. The media of claim 13, wherein the software is further operable when executed to:
detect a companion application associated with the VR system installed on the client system;
embed a deep link to a product detail page associated with the VR application within the content recommendation, wherein the product detail page comprises the interactable element;
receive, from the client system, an indication of a user interaction with the deep link embedded within the content recommendation; and
send, to the client system, instructions for presenting the product detail page within the companion application.

17. A system comprising: one or more processors; and a non-transitory memory coupled to the processors comprising instructions executable by the processors, the processors operable when executing the instructions to:
send, to a client system associated with a user, instructions for presenting a content recommendation associated with a virtual-reality (VR) application, wherein the content recommendation comprises an interactable element for installing the VR application;
receive, from the client system, an indication of an activation of the interactable element for installing the VR application; and
send, to a VR system associated with the user responsive to the indication received from the client system, instructions for automatically downloading the VR application to the VR system, wherein the VR system is separate from the client system, the VR application being automatically installed on the VR system after downloading of the VR application to the VR system.

18. The system of claim 17, wherein the content recommendation associated with the VR application is presented via a first application installed on the client system.

19. The system of claim 18, wherein the processors are further operable when executing the instructions to:
determine a companion application associated with the VR system not installed on the client system;
embed a URL link to a product detail page associated with the VR application within the content recommendation, wherein the product detail page comprises the interactable element;
receive, from the client system, an indication of a user interaction with the URL link embedded within the content recommendation; and
send, to the client system, instructions for directing the user to the product detail page via a web browser.

20. The system of claim 18, wherein the processors are further operable when executing the instructions to:
detect a companion application associated with the VR system installed on the client system;
embed a deep link to a product detail page associated with the VR application within the content recommendation, wherein the product detail page comprises the interactable element;
receive, from the client system, an indication of a user interaction with the deep link embedded within the content recommendation; and
send, to the client system, instructions for presenting the product detail page within the companion application.
